(19) United States
(12) Patent Application Publication
(10) Pub. No.: US 2020/0033265 A1
(43) Pub. Date: Jan. 30, 2020

(54) DIGITAL FINGERPRINTING

(71) Applicant: Diversey, Inc., Charlotte, NC (US)

(72) Inventors: Bernd Paulus, Dossenheim (DE); Tuomas Pahlman, Tampere (FI); Ingo Mistele, Mannheim (DE); Henry von Rege, Alzey (DE); Walter John Watkinson, Matlock (GB)

(73) Assignee: Diversey, Inc.

(21) Appl. No.: 16/048,973

(22) Filed: Jul. 30, 2018

(51) Int. Cl. G01N 21/59; G01N 21/64

(52) U.S. Cl. CPC G01N 21/59; G01N 21/64

(57) ABSTRACT

Analyzers, methods and systems for providing a digital fingerprint or signature for assessing process information and improving process operations using such information. In particular, such analyzers, methods and systems use a unique analysis procedure for identifying, for example, one or more constituents of an intermediate and/or a product-based process stream and providing process operating parameters specific to such one or more constituents. The analyzers, methods and systems may additionally provide dilutions or concentrations of such constituents to improve the understanding of the process operation and how such process operation should be adjusted in response.

### FIELD OF INVENTION

The present invention relates to analyzers, methods and systems for analyzing liquid-based intermediate and product streams in the food and other industrial process industries. The present invention more specifically provides an analysis system capable of identifying types and concentrations of compounds within such liquid-based intermediate and product streams. The present invention also relates to using information provided by the analyzers, methods and systems of the present invention to give specific information concerning the process and controlling the same in response to such information.

### BACKGROUND

The state-of-the-art in online process analysis includes online analyzers of process streams that provide a measurement based upon such analysis. With the exception of certain filtering techniques and quality assessment techniques of the operation of the analyzer, such measurements provided by the online analyzers undergo little further adaptation to assess the characteristics of the compounds and/or constituents that are included in such process streams along with the dilutions and/or concentrations of such compounds and/or constituents.

While it is generally known that spectroscopy involves the interaction of electromagnetic waves with a stream being analyzed to attempt to gain information concerning the stream, variations in transitions between the responses of more than one wavelength of such a stream has not been conventionally used to gain information concerning the compounds and/or constituents within the stream being analyzed or the dilutions and/or concentrations of such compounds and/or constituents within the stream. While certainly it is feasible to conduct a full spectrum analysis in a data intensive application, the costs of analyzers associated therewith is much greater and such an analysis would not be cost effective.

There remains a need in the art for a cost effective and a more rigid analysis using spectroscopy on process streams to gain a better understanding of the compounds and/or constituents within the stream being analyzed as well as the dilutions and/or concentrations of such compounds and/or constituents with the stream. Furthermore, the art needs an analyzer that can provide more detailed and accurate information concerning an intermediate or product process stream to allow for more well informed decisions to be made concerning such processes include selection of process steps associated with such identified compounds and constituents and more efficient control of the process to accommodate the dilutions and/or concentrations of such compounds and/or constituents within the process stream.

### SUMMARY OF INVENTION

The present invention relates to analyzers, methods and systems for analyzing liquid-based intermediate and product streams in the food and other industrial process industries. Without intending to be bound by theory, an analyzer, system and method of the invention allows for the analysis of samples taken from a process plant including, in a nonlimiting example, from an online measurement from which procedures for operation of such a process plant may be coordinated.

An aspect of the invention provides a method for analyzing a sample. In certain embodiments of the invention, the method for analyzing a sample includes the steps of emitting two or more different spectral wavelengths of electromagnetic radiation through the sample; detecting a signal representing the two or more different spectral wavelengths of electromagnetic radiation transmitted through the sample; processing the signal to determine relative intensities of absorption of the two or more different spectral wavelengths; using an analysis technique to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and identifying at least one of a type of a constituent of the sample, a dilution of the constituent in the sample and one or more properties of the constituent of the sample.

In an embodiment of the invention, the electromagnetic radiation of the method may include any one or more of visible light, ultraviolet radiation, and infrared radiation, according to an embodiment of the invention. In certain embodiments of the invention, the signal may represent energy released by a luminescent species naturally present within the sample that becomes excited upon absorbance of at least one of the two or more different spectral wavelengths of electromagnetic radiation transmitted through the sample.

In an embodiment of the invention, the multiplicity of liquid types may be a multiplicity of liquid food types including beverages and dairy products. In yet another embodiment of the invention, the multiplicity of liquid types may be a multiplicity of formulations comprising chemicals, wherein, in certain embodiments of the invention, the multiplicity of formulations comprise cleaning chemicals.

In some embodiments of the invention, the sample includes one of a food, a cleaning formulation, a detergent formulation, a sealant formulation, an adhesive formulation, a preparation for medical or veterinary purposes, a pharmaceutical, a cosmetic, a lotion, a hair gel, a shampoo, a paint, a varnish, a lacquers, a thinner and a thickener. In certain embodiments of the invention, the constituent may be a food in liquefied form, that may include a beverage or a condiment. In certain embodiments of the invention, the constituent may be a dairy product. In other embodiments of the invention, the constituent may be a contaminant instead.

In an embodiment of the invention, the sample may be from a process plant including, in a nonlimiting example, from an online measurement. In certain embodiments of the invention, the sample is from a cleaning process. The cleaning process may be from any industry. For example, in certain embodiments of the invention, the cleaning process is selected from a group consisting of a food cleaning process, a beverage cleaning process, a dairy product cleaning process, a laundry cleaning system, and a dishwasher. In other embodiments of the invention the sample is taken from a process stream.

The method for analyzing a sample may additionally comprise the step of identifying a modification to be made to an operation of the process plant. In certain embodiments of the invention, the process plant is an automated recirculation system. Further pursuant to this embodiment of the invention, the automated recirculation system may be a clean-in place (CIP) process. In certain embodiments of the invention, the operation of the process plant may be a cleaning procedure.

In certain embodiments of the invention, the sample is taken from at least one of a supply line of the CIP process and a return line of the CIP process. In still other embodiments of the invention, the sample is taken from a supply line of the CIP process and another sample is taken from a return line of the CIP process. In an embodiment of the invention, the method for analyzing a sample may additionally comprise the step of using information from the sample and the another sample in identifying the modification to be made to the operation of the process.

Another aspect of the invention provides a method for analyzing a sample comprising the steps of emitting two or more different spectral wavelengths of electromagnetic radiation through the sample; detecting a signal representing the two or more different spectral wavelengths of electromagnetic radiation transmitted through the sample; processing the signal to determine relative intensities of absorption of the two or more different spectral wavelengths; using an analysis technique configured to employ a mathematical procedure comprising a mathematical model to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and identifying at least one of a type of a constituent of the sample, a dilution of the constituent in the sample and one or more properties of the constituent of the sample. Further pursuant to this embodiment of the invention, the mathematical model may include any one or more of a linear model, a nonlinear model, a static model, a dynamic model, a discrete model, a continuous model, an explicit model, an implicit model, a deterministic model, a statistical model, a deductive model, and an inductive model. In an embodiment of the invention, the signal represents energy released by a luminescent species naturally present within the sample that becomes excited upon absorbance of at least one of the two or more different spectral wavelengths of electromagnetic radiation transmitted through the sample.

In an embodiment of the invention, the multiplicity of liquid types may be a multiplicity of liquid food types including beverages or dairy products. In yet another embodiment of the invention, the multiplicity of liquid types may be a multiplicity of formulations comprising chemicals, wherein, in certain embodiments of the invention, the multiplicity of formulations comprise cleaning chemicals.

In yet another aspect of the invention, the invention provides an analyzer having light emitting diodes (LEDs) that provide two or more different spectral wavelengths of electromagnetic radiation; a detector that identifies a signal that represents the two or more different spectral wavelengths of electromagnetic radiation transmitted through a sample; a processor that identifies relative intensities of absorption from the signal; a data repository to hold relative intensities of absorption of a multiplicity of liquid types, relative intensities of absorption for a dilution of the multiplicity of liquid types and relative intensities of absorption of various properties associated with the multiplicity of liquid types; and an evaluator having an analysis technique to compare the relative intensities of absorption of the sample to the relative intensities of absorption in the data repository and to identify at least one of a type of a constituent of the sample, a dilution of the constituent in the sample and one or more properties of the constituent of the sample.

In an embodiment of the invention, the electromagnetic radiation may include any one or more of visible light, ultraviolet radiation, and infrared radiation. In certain embodiments of the invention, the signal represents energy released by a luminescent species naturally present within the sample that becomes excited upon absorbance of at least one of the two or more different spectral wavelengths of electromagnetic radiation transmitted through the sample.

In an embodiment of the invention, the multiplicity of liquid types may be a multiplicity of liquid food types including beverages or dairy products. In yet another embodiment of the invention, the multiplicity of liquid types may be a multiplicity of formulations comprising chemicals, wherein, in certain embodiments of the invention, the multiplicity of formulations comprise cleaning chemicals.

In an embodiment of the invention, the analysis technique of the analyzer may be configured to employ a mathematical procedure to compare the relative intensities of absorption of the sample to the relative intensities of absorption in the data repository. In certain embodiments of the invention, the mathematical procedure includes a mathematical model. Further pursuant to this embodiment of the invention, the mathematical model includes any one or more of a linear model, a nonlinear model, a static model, a dynamic model, a discrete model, a continuous model, an explicit model, an implicit model, a deterministic model, a statistical model, a deductive model, and an inductive model.

In an embodiment of the invention, the constituent of the sample may be a food in liquefied form, such as, for example, a beverage or a condiment. In certain embodiments of the invention, the constituent may be a dairy product. In other embodiments of the invention, the constituent of the sample being analyzed is a contaminant. In an embodiment of the invention, the sample may be from a process plant including, in a nonlimiting example, from an online measurement. In certain embodiments of the invention, the sample is from a cleaning process.

In an embodiment of the invention, the sample is taken from a process stream. In certain embodiments of the invention, the process plant is an automated recirculation system, such as, for example, a clean-in place (CIP) process. In certain embodiments of the invention, the sample is taken from at least one of a supply line of the CIP process and a return line of the CIP process. In an embodiment of the invention, the sample may be taken from a supply line of the CIP, and in other embodiments of the invention, another sample is taken from a return line of the CIP process.

In still yet another embodiment of the invention, a system for analysis of a sample having any of the analyzers and methods described herein is provided. In certain embodiments of the invention the analyzers include a plurality of sensors such as, in a nonlimiting, example two sensors for measurements.

Other aspects and embodiments will become apparent upon review of the following description. The invention, though, is pointed out with particularity by the included claims.

### BRIEF DESCRIPTION OF THE DRAWINGS

Having thus described the invention in general terms, reference will now be made to the accompanying drawings, which are not necessarily drawn to scale, and wherein:

FIG. 1 is a graph representing the absorbance spectra for varying concentrations of ethylenediaminetetraacetic acid (EDTA) in an aqueous solution;

FIG. 2 is a graph representing the absorbance spectra for undiluted beverage products;

FIG. 3 is a graph representing the absorbance spectra for diluted beverage products at various concentrations;

FIG. 4 is a graph representing the absorbance spectra for various concentrations of orange juice including four wavelengths of LEDs used in fingerprinting the orange juice;

FIG. 5 is a 3D graph representing the fingerprint for orange juice according to an embodiment of the invention showing the normalized absorbance of the solution at varying concentrations of solution and wavelengths of measurement;

FIG. 6 is a table illustrating the Gaussian-based fingerprint values that shows there is a sufficient separation of absorbance at varying wavelengths to allow either milk, orange juice, COKE, FANTA, lager beer, or energy drink products to be distinguished among themselves;

FIG. 7 is a table illustrating the Gaussian-based fingerprint values that shows there is a sufficient separation of absorbance at varying wavelengths to allow either milk, orange juice, VOLVIC Juicy, apple spritzer, COKE, FANTA, lager beer, energy drink or SPRITE products to be distinguished among themselves.

FIG. 8 is a graph showing the absorbance associated with COKE, COKE Light and COKE ZERO at varying wavelengths having concentrations of 10% and 5% measured using a 1 cm sample cell;

FIG. 9 is a graph showing the relative intensity for COKE, COKE Light and COKE ZERO at varying concentrations at the wavelengths of 225 nm and 280 nm using a 1 cm sample cell where the Gaussians used to simulate intensities are shown in FIG. 8;

FIG. 10 is a graph showing the absorbance associated with COKE, COKE Light and COKE ZERO at varying wavelengths having concentrations of 5% and 1% measured using a 5 cm sample cell;

FIG. 11 is a graph showing the simulated relative intensity for COKE, COKE Light and COKE ZERO at varying concentrations at the wavelengths of 225 nm and 280 nm using a 5 cm sample cell where the Gaussians used to simulate intensities are shown in FIG. 10;

FIG. 12A shows the relative intensities at varying concentrations of COKE at the wavelengths of 225 nm and 280 nm using a 5 cm sample cell;

FIG. 12B shows the relative intensities at varying concentrations of COKE Light at the wavelengths of 225 nm and 280 nm using a 5 cm sample cell;

FIG. 12C shows the relative intensities at varying concentrations of COKE ZERO at the wavelengths of 225 nm and 280 nm using a 5 cm sample cell;

FIG. 13 is a graph showing the absorbance associated with FANTA and FANTA ZERO at varying wavelengths having concentrations of 10% and 5% measured using a 1 cm sample cell;

FIG. 14 is a graph showing the simulated relative intensity for FANTA and FANTA ZERO at varying concentrations at the wavelengths of 240 nm and 330 nm using a 1 cm sample cell where the Gaussians used to simulate intensities are shown in FIG. 13;

FIG. 15 is a graph showing the absorbance associated with FANTA and FANTA ZERO at varying wavelengths having concentrations of 5% and 1% measured using a 5 cm sample cell;

FIG. 16 is a graph showing the simulated relative intensity for FANTA and FANTA ZERO at varying concentrations at the wavelengths of 240 nm and 330 nm using a 5 cm sample cell where the Gaussians used to simulate intensities are shown in FIG. 15;

FIG. 17 is a graph showing the absorbance associated with SPRITE and SPRITE ZERO at varying wavelengths having concentrations of 100% and 50% measured using a 1 cm sample cell;

FIG. 18 is a graph showing the simulated relative intensity for SPRITE and SPRITE ZERO at varying concentrations at the wavelengths of 270 nm and 320 nm using a 1 cm sample cell where the Gaussians used to simulate intensities are shown in FIG. 17;

FIG. 19 is a graph showing the absorbance associated with SPRITE and SPRITE ZERO at varying wavelengths having concentrations of 100% and 50% measured using a 5 cm sample cell;

FIG. 20 is a graph showing the simulated relative intensity for SPRITE and SPRITE ZERO at varying concentrations at the wavelengths of 270 nm and 320 nm using a 5 cm sample cell where the Gaussians used to simulate intensities are shown in FIG. 19;

FIG. 21 is a graph showing the simulated intensity for SPRITE and SPRITE ZERO at varying concentrations at the wavelengths of 270 nm and 320 nm using a 1 cm sample cell;

FIG. 22 is a graph showing the simulated intensity for SPRITE and SPRITE ZERO at varying concentrations at the wavelengths of 270 nm and 320 nm using a 5 cm sample cell;

FIG. 23 is a graph showing the normalized intensity for COKE at varying concentrations at 370 nm using Sensor 1 and Sensor 2, two actual sensors, and simulation values measured using a 1 cm sample cell and a 5 cm sample cell, respectively;

FIG. 24 is a graph showing the normalized intensity for COKE Light at varying concentrations at 370 nm using Sensor 1 and Sensor 2, two actual sensors, and simulation values measured using a 1 cm sample cell and a 5 cm sample cell, respectively;

FIG. 25 is a graph showing the normalized intensity for COKE ZERO at varying concentrations at 370 nm using Sensor 1 and Sensor 2, two actual sensors, and simulation values measured using a 1 cm sample cell and a 5 cm sample cell, respectively; and

FIG. 26 is a graph showing the absorbance of raw materials that may be used in cleaning formulations at varying wavelengths in the UV range having different compounds included in the formulation.

### DETAILED DESCRIPTION OF THE INVENTION

The present invention now will be described more fully hereinafter. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “a sensor measurement” includes a plurality of such sensor measurements.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As used herein, a “digital fingerprint” refers to using measurement data from an analytical technique to determine the type of material being processed and the concentration of such material within the stream. In a particular embodiment of the invention, the digital fingerprint is determined by using two or more different wavelengths measured on the stream and their relative intensity of absorption.

The term “sensor” as used herein is a broad term, and is to be given its ordinary and customary meaning to a person of ordinary skill in the art and is not to be limited to a special or customized meaning unless otherwise provided herein. In a non-limiting embodiment, “sensor” may refer to the portion of a device, a measurement device in a non-limiting sense, for determining a desired property of the solution or the liquid undergoing analysis. In an embodiment of the invention, the “sensor” may comprise an emitter and detector pair. In yet another embodiment of the invention, the “sensor” may comprise more than one emitters and/or detectors.

The inventors have conceived of a way to distinguish amongst process streams, in non-limiting examples, beverage products and dairy products, by measuring absorption at specific wavelengths. Without intending to be limiting such process streams may include the beverage product or the dairy product itself, raw materials associated with the manufacture of the product, intermediate process streams including perhaps the product and cleaning agents, and the like. Such information may be useful, in a non-limiting example, in automating the cleaning protocol of a process based upon the product that has been identified. The inventors having additionally conceived of detecting concentrations, such as, in a non-limiting example, trace amounts of compounds in such products as well as any associated process streams. For example, such a technique is useful in identifying whether a certain process phase, such as a rinse step or a cleaning step, is complete or not.

While the exemplary fingerprinting technique of the invention further described herein is for measurements in the beverage industry and dairy products industry, application of the fingerprinting technique has been contemplated and even tested for measurements from other processes and for other products other than beverage products and dairy products as well. In addition to beverages and dairy products, the technique of the invention can be used with any other type of food or dilutions thereof such as, for example, an aqueous dilution thereof, such as, without intending to be limiting, ketchup, mustard, egg, yoghurt, sauces, chocolate and the like. In addition to food including beverages and any dilution thereof, the technique of the invention may be used for any chemical based formulation such as, in nonlimiting examples, cleaning formulations, detergent formulations, sealant and/or adhesive formulations, preparations for medical or veterinary purposes such as chemical preparations perhaps, pharmaceuticals, cosmetics, lotions, hair gels and shampoos, and paints, varnishes, lacquers, thinners and thickeners. Indeed, the technique of the invention may be used for any chemical solution in a process or product including any dilution thereof. Some of these techniques are further disclosed herein.

Using the analytical technique of absorption spectroscopy in the range of ultraviolet, visible, and near-infrared light, it is possible to automatically determine the type of beverage, dairy product, or liquid food or their aqueous dilutions with a sensor. This can be done using two or more different wavelengths (e.g. via two LEDs) and their relative intensity of absorption. Commercially available LEDs with different wavelengths may be used in the invention. The sensor data measurements in combination with appropriate data analysis techniques can produce unique fingerprints for proper identification as further defined herein.

In certain embodiments of the invention, one or more wavelengths of the analytical technique may provide a luminescence function based upon the inherent content of the beverage, dairy product, liquid food or whatever other compound is being searched for in the sample. As used herein, “luminescence” is where energy is delivered to a sensitive molecular species through absorbance of ultraviolet, visible, and/or near-infrared light causing the molecular species to produce an excited state. The sensitive molecular species that produces the excited state may also be referred to herein as the luminescent species. Return to a lower energy state is accompanied by release of the light energy that has been absorbed. This released light energy may be of a different wavelength and energy characteristic than that which was originally absorbed. This emitted light energy to return the molecular species to its unexcited state itself can be measured to determine the presence of the compound having the molecular species or the concentration of the compound in the sample being analyzed based upon the amount of light energy released by the excited molecular species. Luminescence includes fluorescence, phosphorescence, chemiluminescence and bioluminescence, for example. However, other molecular species may also be excited in a similar manner as well.

The technology and approach of the invention, may be used to automatically determine the product such as, in a nonlimiting example a dairy product and/or beverage and/or the concentration of the same in a production facility. This information can be used, for example, to automatically trigger a specific cleaning program which is optimized for the soil typically found within such product such as, in a nonlimiting example, a dairy product and/or beverage.

The fingerprinting and automatic detection of soil type can result in even larger potential savings on the use of water and energy in, for example, a clean-in-place (CIP) process. Studies of rinse properties of food substances using the technique of the invention can provide valuable additional information for further optimization of cleaning processes. In a second step fingerprinting may be used for automatic cleaning agent identification and control the concentration or make determination concerning other downstream processes like the automated selection of the correct packaging and labelling of the product.

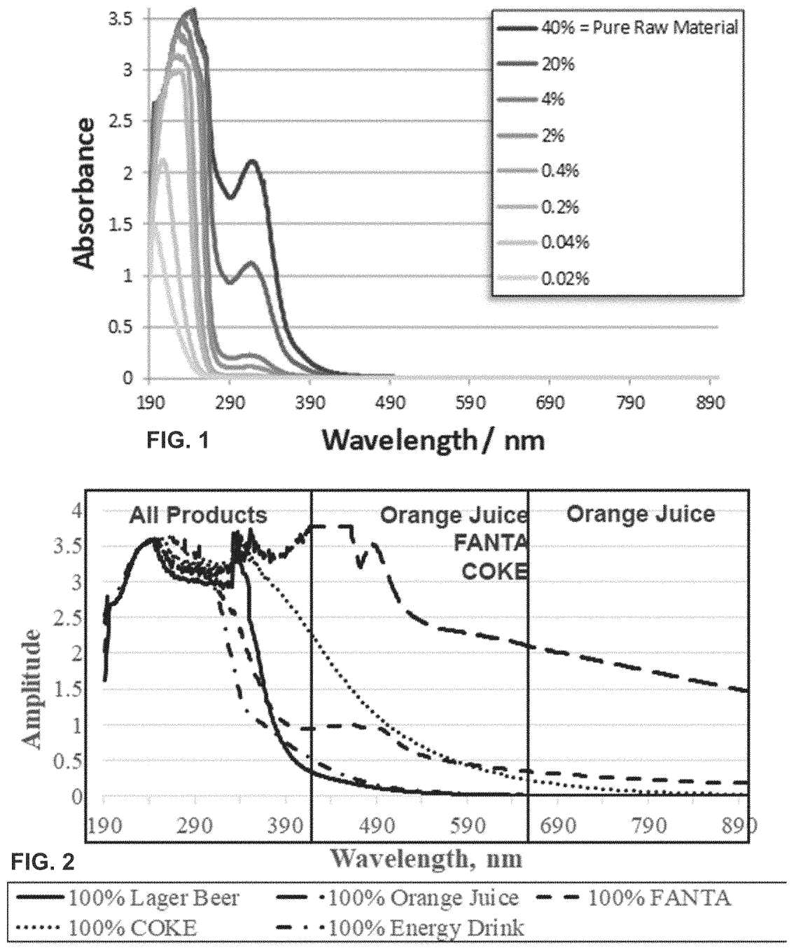

FIG. 1 is a graph representing the absorbance spectra for varying concentrations of ethylenediaminetetraacetic acid (EDTA) in an aqueous solution. As the graph in FIG. 1 shows, the absorbance spectra may be used, particularly at a wavelength where the absorbance is distinctly different, to determine the concentration of, for example, a cleaning compound such as EDTA in a solution. Indeed, the concentration of the compound may be more accurately determined by using measured absorbances from more than one wavelength taken from a solution.

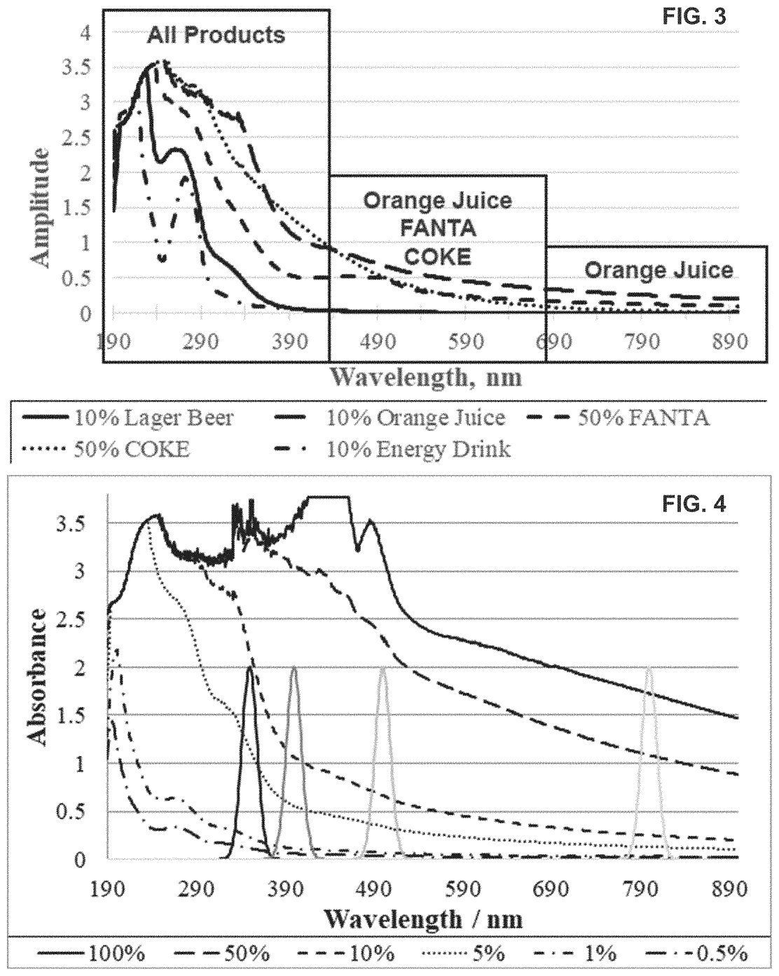

FIG. 2 is a graph representing the absorbance spectra for undiluted beverage products while FIG. 3 is a graph representing the absorbance spectra for diluted beverage products at varying concentrations. As FIG. 2 illustrates, the measured absorbances are distinctive for each of the undiluted beverage products up to about 400 nm; orange juice, COKE®, and FANTA® (the latter two available from the Coca-Cola Company, Atlanta, Ga., USA) from about 400 nm to about 650 nm, and only orange juice among these illustrated beverages above about 650 nm. Similarly, even though the beverages are diluted in FIG. 3, it demonstrates again that the measured absorbances are distinctive for each of the undiluted beverage products up to about 400 nm; orange juice, COKE, and FANTA from about 400 nm to about 650 nm, and orange juice above about 650 nm Thus, the technique for distinguishing among products of the invention, must use the measured absorbances from those spectra for the product intending to be detected.

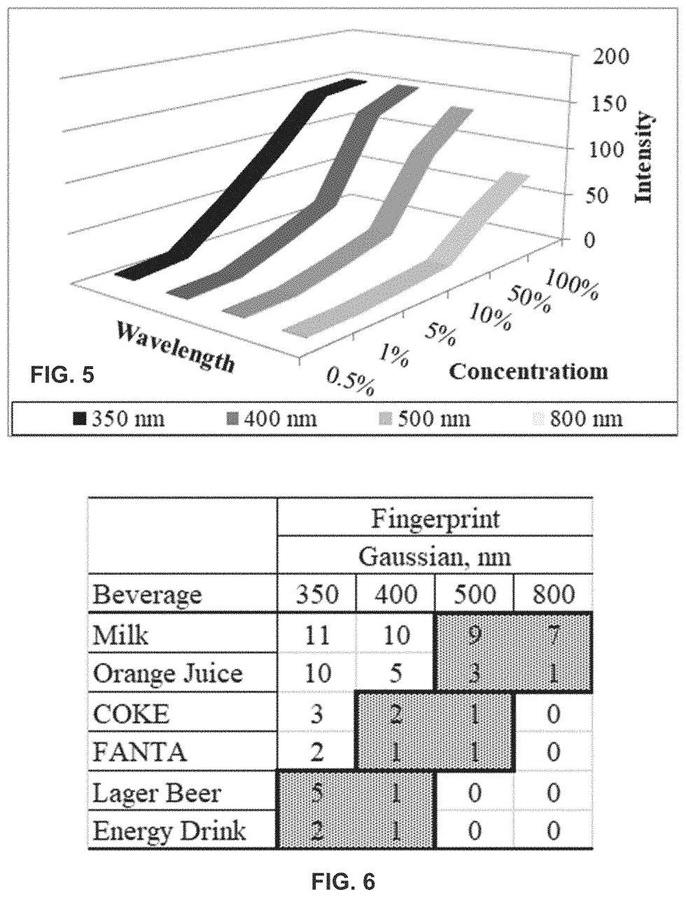

FIG. 4 is a graph representing the absorbance spectra for various concentrations of orange juice including four wavelengths of LEDs used in fingerprinting the orange juice. The information from FIG. 4 is used to generate the digital fingerprint for orange juice. FIG. 5 is a 3D graph representing the fingerprint for orange juice according to an embodiment of the invention showing the normalized absorbance of the solution at varying concentrations of solution for selected wavelengths of measurement. The digital fingerprint for any beverage or any other product or intermediate process stream may be similarly generated by taking the absorbance spectra for various concentrations of the beverage, product or intermediate process stream similar to that found in FIG. 4 and generating the digital fingerprint for such beverage, product or intermediate process stream similar to that found in FIG. 5. In a preferred embodiment, multiple samples are measured at the selected concentrations and wavelengths, and the average of the values are taken with statistical outliers optionally not being included in the average.

In another embodiment of the invention, relative intensities may be used as opposed to the actual intensity measured. According to this embodiment of the invention, the absorbances are measured at various concentrations of the beverage or product, and each of the measured absorbances are divided by the maximum value in each concentration. Table 1A shows the values for orange juice when the actual intensities are used in the digital fingerprint, while Table 1B shows the values for orange juice when the relative intensities are used in the digital fingerprint.

TABLE 1A

| | Orange Juice | | | |
|---|---|---|---|---|
| | Intensity | | | |
| | Wavelength | | | |
| Concentration | 350 nm | 400 nm | 500 nm | 800 nm |
| 100% | 148.9 | 150.3 | 134.8 | 73.5 |
| 50% | 143.0 | 130.1 | 97.8 | 46.1 |
| 10% | 92.8 | 45.9 | 28.3 | 10.7 |
| 5% | 49.3 | 24.0 | 14.6 | 5.5 |
| 1% | 9.9 | 4.9 | 3.0 | 1.2 |
| 0.5% | 4.9 | 2.5 | 1.5 | 0.7 |

TABLE 1B

| | Orange Juice | | | |
|---|---|---|---|---|
| | Relative Intensity | | | |
| | Wavelength | | | |
| Concentrations | 350 nm | 400 nm | 500 nm | 800 nm |
| 100% | 0.99 | 1.00 | 0.90 | 0.49 |
| 50% | 0.95 | 0.87 | 0.65 | 0.31 |
| 10% | 0.62 | 0.31 | 0.19 | 0.07 |
| 5% | 0.33 | 0.16 | 0.10 | 0.04 |
| 1% | 0.07 | 0.03 | 0.02 | 0.01 |
| 0.5% | 0.03 | 0.02 | 0.01 | 0.00 |

Special considerations need to be made when taking spectral measurements. For example, the spectral width of the spectral LED must demonstrate a sufficient separation of wavelengths to provide useful distinguishing information for the sample being measured. Furthermore, there must be a sufficient change in amplitude over the spectral width in order to obtain distinguishing information on the sample. The length of the light path for the measurement should at least be equivalent to the tube diameter where the sample is being directed. Finally, the measurement signal must be significantly strong enough to overcome any background noise and to obtain pronounced intensity differences to provide a distinguishing digital fingerprint measurement.

An aspect of the invention provides an analyzer comprising light emitting diodes (LEDs) that provide two or more different spectral wavelengths of electromagnetic radiation; a detector that identifies a signal that represents the two or more different spectral wavelengths of electromagnetic radiation transmitted through a sample; a processor that identifies relative intensities of absorption from the signal; a data repository to hold relative intensities of absorption of a multiplicity of liquid types, relative intensities of absorption for a dilution of the multiplicity of liquid types and relative intensities of absorption of various properties associated with the multiplicity of liquid types; and an evaluator having an analysis technique to compare the relative intensities of absorption of the sample to the relative intensities of absorption in the data repository and to identify at least one of a type of a constituent of the sample, a dilution of the constituent in the sample and one or more properties of the constituent of the sample.

In an embodiment of the invention, the multiplicity of liquid types may comprise a liquid and a liquid food type including a beverage and a dairy product. In yet another embodiment of the invention, the multiplicity of liquid types may be a formulation wherein such formulation comprises one or more chemicals. In certain embodiments of the invention, such one or more chemicals may comprise cleaning chemicals.

In an embodiment of the invention a measured value of electromagnetic radiation coming directly from the analyzer may be used in the analysis technique. In yet other embodiments of the invention, a Gaussian absorbance model may be used in the analysis technique. Further pursuant to these other embodiments of the invention, a full width at half maximum (FWHM) and an absorbance must be provided in order to determine the Gaussian absorbance. The FWHM is a parameter commonly used to describe the width of the values representing the curve or function and is given by the distance between points on the curve at which the function reaches half its maximum value. In a non-limiting example, a normal distribution or Gaussian curve represented by the formula exp(−(x−μ)²/(2σ²)) where x is the wavelength, μ is the mean value and σ is the standard deviation has a FWHM represented by 2\sqrt{2ln2}σ; however, curves better characterized by other formulas having a different FWHM may be more representative of the samples taken by the measurement system according to certain embodiments of the invention. The amplitude is the peak value represented in the normal distribution of the Gaussian curve or any other type of measurement system chosen to represent the measured value. In certain embodiments of the invention, some other value based upon the measure value may be used in establishing the best representation of the curve. In an embodiment of the invention, a relative intensity of absorption may be represented by the representative curve.

In certain embodiments of the invention, a fitting technique is used to determine the best representation of the values received from the measurement system, and the values determined from the fitting technique is used in representing the measured value of the absorbance from the analyzer. In an embodiment of the invention, the best representation of values received from the measurement system are those that distinguish best between different measurements received from the measurement system.

In an embodiment of the invention, the analysis technique of the analyzer may be configured to employ a mathematical procedure to compare the relative intensities of absorption of the sample to the relative intensities of absorption in the data repository. In certain embodiments of the invention, the mathematical procedure comprises a mathematical model. Further pursuant to this embodiment of the invention, the mathematical model includes any one or more of a linear model, a nonlinear model, a static model, a dynamic model, a discrete model, a continuous model, an explicit model, an implicit model, a deterministic model, a statistical model, a deductive model, and an inductive model.

In an embodiment of the invention, the electromagnetic radiation may include any one or more of visible light, ultraviolet radiation, and infrared radiation.

In another embodiment of the invention, the constituent of the sample being analyzed is a food in liquefied form. In certain embodiments of the invention, the food in liquefied form is a beverage. Further pursuant to this embodiment of the invention, the food in liquefied form is a condiment. In certain other embodiments of the invention, the constituent of the sample being analyzed is a dairy product. In yet other embodiments of the invention, the constituent of the sample being analyzed is a contaminant.

In yet another embodiment of the invention, the sample may be from a process plant including, in a nonlimiting example, from an online measurement. In certain embodiments of the invention, the sample is from a cleaning process, in a non-limiting example. In certain other embodiments of the invention, the sample may be taken from a process stream. Further pursuant to this embodiment of the invention, the process plant may be an automated recirculation system. In certain embodiments of the invention, the automated recirculation system is a clean-in place (CIP) process.

In yet even another embodiment of the invention, the sample may be taken from at least one of a supply line of the CIP process and a return line of the CIP process. Reference is made to U.S. Pat. No. 9,676,011 and U.S. Patent Application Publication No. 2017/0231458 both entitled “Control Technique for Multistep Washing Process Using a Plurality of Chemicals” to Pahlman, fully included herein by reference. In still yet another embodiment of the invention, the sample may be taken from a supply line of the CIP process and another sample is taken from a return line of the CIP process.

In an embodiment of the invention, a processor that may identify relative intensities of absorption from a detected signal that represents two or more different spectral wavelengths of electromagnetic radiation transmitted through a sample is provided. In an embodiment of the invention, this comprises taking a first intensity of absorption from one spectral wavelength as a dividend and taking a second intensity of absorption from another spectral wavelength as the divisor. The relative intensity of absorption is the number of times the divisor divides into the dividend including any fractional amount thereof. In an embodiment of the invention, the relative intensity of absorption is the number of times the divisor divides into the dividend including any fractional amount thereof multiplied by a factor. In certain embodiments of the invention, merely the quotient may be taken as the relative intensity of absorption or the whole number in the event the number is multiplied by a factor may alternatively be used. In certain other embodiments of the invention, the number of times the divisor divides into the dividend including any fractional amount thereof or, in the event a factor is used, such number multiplied by such factor is rounded up or down to the nearest whole number depending on the value of the fractional amount.

In an embodiment of the invention, the relative intensities of absorption may be determined by some other mathematical procedure. In certain embodiments of the invention, a relative intensity of absorption is determined based upon a Gaussian distribution of the intensities of absorption from the spectral wavelengths. In a more specific embodiment of the invention, a relative intensity of radiation is a Gaussian integer based upon the Gaussian value determinations from the spectral wavelengths of each respective wavelength used in determining the relative intensity of absorption. In certain other embodiments of the invention, a factor may be used to determine this Gaussian integer to find the relative of the Gaussian distribution of the intensities of absorption from the spectral wavelengths.

In another aspect, the invention provides a method for analyzing a sample. In an embodiment of the invention, the method for analyzing the sample comprise the steps of emitting two or more different spectral wavelengths of electromagnetic radiation through the sample; detecting a signal representing the two or more different spectral wavelengths of electromagnetic radiation transmitted through the sample; processing the signal to determine relative intensities of absorption of the two or more different spectral wavelengths; using an analysis technique to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and identifying at least one of a type of a constituent of the sample, a dilution of the constituent in the sample and one or more properties of the constituent of the sample. In an embodiment of the invention, the electromagnetic radiation may include any one or more of visible light, ultraviolet radiation, and infrared radiation.

In an embodiment of the invention, the multiplicity of liquid types may be a multiplicity of liquid food types including beverages and dairy products. In yet another embodiment of the invention, the multiplicity of liquid types may be a multiplicity of formulations comprising chemicals, wherein, in certain embodiments of the invention, the multiplicity of formulations comprise cleaning chemicals.

In certain embodiments of the invention, the sample being analyzed includes a constituent that is a food in liquefied form. In certain embodiments of the invention, the food in liquefied form is a beverage. In certain other embodiments of the invention, the food in liquefied form is a condiment. In still other embodiments of the invention, the food is a dairy product. In yet other embodiments of the invention, the constituent is a contaminant.

In an embodiment of the invention, the sample is from a process plant including, in a nonlimiting example, from an online measurement. In certain embodiments of the invention, the sample is from a cleaning process. Further pursuant to this embodiment of the invention, the cleaning process is selected from a group consisting of a food cleaning process, a beverage cleaning process, a dairy product cleaning process, a laundry cleaning system, and a dishwasher.

In an embodiment of the invention, the sample may be taken from a process stream. The method for analyzing a sample may additionally comprise the step of identifying a modification to be made to an operation of the process plant.

In an embodiment of the invention, the process plant from which a sample is further analyzed is an automated recirculation system. The automated recirculation system may be a clean-in place (CIP) process, according to another embodiment of the invention, In certain embodiments of the invention, the operation of the plant may be a cleaning procedure.

In certain embodiments of the invention, the sample is taken from at least one of a supply line of the CIP process and a return line of the CIP process. Further pursuant to this embodiment of the invention, the sample may be taken from a supply line of the CIP process and another sample is taken from a return line of the CIP process.

In another embodiment of the invention, the method of analyzing a sample may additionally comprise the step of using information from the sample and the another sample in identifying the modification to be made to the operation of the process. The modification may include a manual action and/or operation, an automatic action and/or operation, or a combination of a manual and an automatic action and/or operation. In certain embodiments of the invention, nonlimiting examples of the modification to be made includes selecting the correct cleaning process to be used and/or the correct cleaning protocol to undertake. In a nonlimiting example, when the type of product is being ascertained, once that product is determined, then the appropriate action to be undertaken may be invoking a recipe specific to that product or a cleaning protocol specific to that product.

In yet another aspect of the invention, a method for analyzing a sample is provided comprising the steps of emitting two or more different spectral wavelengths of electromagnetic radiation through the sample; detecting a signal representing the two or more different spectral wavelengths of electromagnetic radiation transmitted through the sample; processing the signal to determine relative intensities of absorption of the two or more different spectral wavelengths; using an analysis technique configured to employ a mathematical procedure comprising a mathematical model to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and identifying at least one of a type of a constituent of the sample, a dilution of the constituent in the sample and one or more properties of the constituent of the sample.

In an embodiment of the invention, the multiplicity of liquid types may be a multiplicity of liquid food types including, in nonlimiting examples, beverages and dairy products. In yet another embodiment of the invention, the multiplicity of liquid types may be a multiplicity of formulations comprising chemicals, wherein, in certain embodiments of the invention, the multiplicity of formulations comprise cleaning chemicals.

In an embodiment of the invention, the mathematical model may include any one or more of a linear model, a nonlinear model, a static model, a dynamic model, a discrete model, a continuous model, an explicit model, an implicit model, a deterministic model, a statistical model, a deductive model, and an inductive model.

In yet another aspect of the invention, a system is provided having an analyzer. According to an embodiment of the invention, the analyzer may comprise any one or more of light emitting diodes (LEDs) that provide two or more different spectral wavelengths of electromagnetic radiation; a detector that identifies a signal that represents the two or more different spectral wavelengths of electromagnetic radiation transmitted through a sample; a processor that identifies relative intensities of absorption from the signal; a data repository to hold relative intensities of absorption of a multiplicity of liquid types, relative intensities of absorption for a dilution of the multiplicity of liquid types and relative intensities of absorption of various properties associated with the multiplicity of liquid types; and an evaluator having an analysis technique to compare the relative intensities of absorption of the sample to the relative intensities of absorption in the data repository and to identify at least one of a type of a constituent of the sample, a dilution of the constituent in the sample and one or more properties of the constituent of the sample. In an embodiment of the invention, the multiplicity of liquid types may be a multiplicity of liquid food types including beverages. In certain embodiments of the invention, the multiplicity of liquid types may be a multiplicity of liquid food types including dairy products. In yet another embodiment of the invention, the multiplicity of liquid types may be a multiplicity of formulations comprising chemicals, wherein, in certain embodiments of the invention, the multiplicity of formulations comprise cleaning chemicals.

In an embodiment of the invention, the system may include a method for analyzing a sample that may comprise any one or more of emitting two or more different spectral wavelengths of electromagnetic radiation through the sample; detecting a signal representing the two or more different spectral wavelengths of electromagnetic radiation transmitted through the sample; processing the signal to determine relative intensities of absorption of the two or more different spectral wavelengths; using an analysis technique to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and identifying at least one of a type of a constituent of the sample, a dilution of the constituent in the sample and one or more properties of the constituent of the sample. In an embodiment of the invention, the electromagnetic radiation may include any one or more of visible light, ultraviolet radiation, and infrared radiation. In an embodiment of the invention, the multiplicity of liquid types may be a multiplicity of liquid food types including, in nonlimiting examples, beverages and dairy products. In yet another embodiment of the invention, the multiplicity of liquid types may be a multiplicity of formulations comprising chemicals, wherein, in certain embodiments of the invention, the multiplicity of formulations comprise cleaning chemicals.

### EXAMPLES

The invention is further defined by reference to the following examples, which describe and shows the results for certain digital fingerprinting techniques and methods of the invention. The performance of such techniques and methods as had been determined is shown in these examples.

The exemplary data included herein was mainly created using a standard lab photometer which is capable of scanning a wide range of spectral wavelengths. In certain instances, some values were validated using a Ciptec sensor (Diversey, Charlotte, N.C.) in its current set up with wavelengths of 370 nm and 875 nm.

### Example 1

In this exemplary data, both the measured and Gaussian absorbances for varying concentrations of milk, orange juice, COKE, FANTA, lager beer and an energy drink at 350 nm, 400 nm, 500 nm and 800 nm is shown in Table 2.

TABLE 2

| | | Absorbance | | | | | | | |
|---|---|---|---|---|---|---|---|---|---|
| | | Measured Wavelength, | | | | | | | |
| Beverage/ | | nm | | | | Gaussian, nm | | | |
| Dairy Product | % | 350 | 400 | 500 | 800 | 350 | 400 | 500 | 800 |
| Milk | 100 | 3.739 | 3.762 | 3.803 | 3.233 | 158.63 | 160.12 | 161.93 | 137.80 |
| | 50 | 3.739 | 3.711 | 3.803 | 3.08 | 156.37 | 155.61 | 161.90 | 130.81 |
| | 10 | 3.218 | 2.975 | 3.04 | 2.621 | 131.90 | 126.87 | 129.14 | 111.40 |
| | 5 | 2.902 | 2.744 | 2.727 | 2.302 | 121.19 | 117.09 | 115.71 | 98.01 |
| | 1 | 1.992 | 1.831 | 1.492 | 0.68 | 84.84 | 78.01 | 63.51 | 29.00 |
| | 0.5 | 1.369 | 1.152 | 0.814 | 0.337 | 58.33 | 49.04 | 34.68 | 14.38 |
| Orange Juice | 100 | 3.549 | 3.526 | 3.172 | 1.727 | 148.95 | 150.31 | 134.76 | 73.51 |
| | 50 | 3.48 | 3.024 | 2.295 | 1.083 | 143.01 | 130.06 | 97.83 | 46.14 |
| | 10 | 2.171 | 1.062 | 0.665 | 0.251 | 92.84 | 45.94 | 28.31 | 10.68 |
| | 5 | 1.145 | 0.556 | 0.343 | 0.13 | 49.27 | 24.04 | 14.60 | 5.53 |
| | 1 | 0.23 | 0.113 | 0.07 | 0.029 | 9.89 | 4.87 | 2.99 | 1.25 |
| | 0.5 | 0.115 | 0.057 | 0.036 | 0.017 | 4.94 | 2.46 | 1.53 | 0.72 |
| COKE | 100 | 3.294 | 2.581 | 1.024 | 0.058 | 143.40 | 109.89 | 43.77 | 2.49 |
| | 50 | 1.878 | 1.274 | 0.499 | 0.03 | 80.17 | 54.42 | 21.32 | 1.29 |
| | 10 | 0.37 | 0.25 | 0.099 | 0.009 | 15.76 | 10.68 | 4.23 | 0.39 |
| | 5 | 0.184 | 0.124 | 0.05 | 0.007 | 7.86 | 5.32 | 2.14 | 0.29 |
| | 1 | 0.04 | 0.027 | 0.012 | 0.005 | 1.71 | 1.18 | 0.53 | 0.22 |
| | 0.5 | 0.024 | 0.017 | 0.008 | 0.005 | 1.01 | 0.71 | 0.36 | 0.22 |
| FANTA | 100 | 1.926 | 0.957 | 0.904 | 0.229 | 82.73 | 41.43 | 37.77 | 9.77 |
| | 50 | 1.015 | 0.508 | 0.476 | 0.123 | 43.81 | 22.00 | 19.88 | 5.22 |
| | 10 | 0.189 | 0.094 | 0.089 | 0.026 | 8.13 | 4.09 | 3.72 | 1.11 |
| | 5 | 0.086 | 0.043 | 0.041 | 0.014 | 3.72 | 1.88 | 1.74 | 0.60 |
| | 1 | 0.024 | 0.013 | 0.012 | 0.007 | 1.03 | 0.56 | 0.52 | 0.30 |
| | 0.5 | 0.015 | 0.009 | 0.008 | 0.006 | 0.65 | 0.39 | 0.35 | 0.26 |
| Lager Beer | 100 | 2.462 | 0.497 | 0.099 | 0.007 | 111.24 | 22.24 | 4.26 | 0.30 |
| | 50 | 1.478 | 0.254 | 0.053 | 0.007 | 66.69 | 11.35 | 2.29 | 0.29 |
| | 10 | 0.289 | 0.052 | 0.013 | 0.006 | 12.98 | 2.33 | 0.58 | 0.26 |
| | 5 | 0.146 | 0.028 | 0.009 | 0.006 | 6.54 | 1.27 | 0.38 | 0.25 |
| | 1 | 0.032 | 0.009 | 0.005 | 0.006 | 1.42 | 0.41 | 0.21 | 0.24 |
| | 0.5 | 0.019 | 0.007 | 0.005 | 0.005 | 0.85 | 0.31 | 0.20 | 0.23 |
| Energy Drink | 100 | 1.15 | 0.663 | 0.131 | 0.003 | 51.39 | 28.46 | 5.68 | 0.13 |
| | 50 | 0.557 | 0.321 | 0.063 | 0.002 | 24.83 | 13.75 | 2.74 | 0.10 |
| | 10 | 0.1 | 0.058 | 0.012 | 0.002 | 4.50 | 2.48 | 0.51 | 0.09 |
| | 5 | 0.05 | 0.029 | 0.006 | 0.002 | 2.26 | 1.25 | 0.27 | 0.09 |
| | 1 | 0.011 | 0.007 | 0.002 | 0.002 | 0.49 | 0.27 | 0.09 | 0.09 |
| | 0.5 | 0.008 | 0.005 | 0.002 | 0.002 | 0.35 | 0.20 | 0.08 | 0.11 |

Using the results from Table 2, the relative intensity of absorption represented by a whole number multiplied by a factor is shown in Table 3.

TABLE 3

| | Fingerprint | | | | | | | |
|---|---|---|---|---|---|---|---|---|
| | Measured Wavelength, | | | | | | | |
| Beverage/ | nm | | | | Gaussian*, nm | | | |
| Dairy Product | 350 | 400 | 500 | 800 | 350 | 400 | 500 | 800 |
| Milk | 11 | 10 | 9 | 6 | 11 | 10 | 9 | 7 |
| Orange Juice | 9 | 5 | 3 | 1 | 10 | 5 | 3 | 1 |
| COKE | 3 | 2 | 1 | 0 | 3 | 2 | 1 | 0 |
| FANTA | 2 | 1 | 1 | 0 | 2 | 1 | 1 | 0 |
| Lager Beer | 5 | 1 | 0 | 0 | 5 | 1 | 0 | 0 |
| Energy Drink | 2 | 1 | 0 | 0 | 2 | 1 | 0 | 0 |

*Gaussian Properties: FWHM - 30 nm, Amplitude - 1.5

FIG. 6 is a table illustrating the Gaussian-based fingerprint values of Table 3, which shows there is a sufficient separation of absorbance at varying wavelengths to allow either the milk, orange juice, COKE, FANTA, lager beer, or energy drink products to be distinguished among the products so identified here.

### Example 2

In this exemplary data, both the measured and Gaussian absorbances for varying concentrations of COKE, COKE Light, COKE ZERO®, COKE LIFE®, SPRITE®, and SPRITE ZERO® (these trademark names associated with products available from the Coca-Cola Company, Atlanta, Ga., USA); VOLVIC® juicy (available from Societe des Eaux de Volvic, groupe Danone, ZI du Chancet, France) and apple spritzer at 285 nm, 350 nm, 400 nm, 500 nm and 850 nm is shown in Table 4.

TABLE 4

| | | Absorbance | | | | | | | | | |
|---|---|---|---|---|---|---|---|---|---|---|---|
| | | Measured Wavelength, nm | | | | | Gaussian, nm | | | | |
| Beverage | % | 285 | 350 | 400 | 500 | 850 | 285 | 350 | 400 | 500 | 850 |
| COKE | 100 | 3.131 | 3.256 | 2.608 | 1.047 | 0.036 | 150.86 | 153.62 | 124.23 | 50.51 | 1.73 |
| | 50 | 3.125 | 1.917 | 1.31 | 0.51 | 0.017 | 147.15 | 93.07 | 63.01 | 24.62 | 0.83 |
| | 10 | 0.97 | 0.378 | 0.254 | 0.098 | 0.003 | 43.64 | 18.24 | 12.24 | 4.72 | 0.16 |
| | 5 | 0.481 | 0.185 | 0.124 | 0.047 | 0.001 | 21.59 | 8.94 | 5.96 | 2.26 | 0.05 |
| | 1 | 0.088 | 0.032 | 0.02 | 0.006 | 0 | 3.94 | 1.55 | 0.98 | 0.31 | 0.00 |
| | 0.5 | 0.039 | 0.012 | 0.007 | 0.001 | −0.001 | 1.72 | 0.60 | 0.34 | 0.06 | −0.05 |
| | 0.1 | −0.001 | −0.004 | −0.003 | −0.003 | −0.001 | −0.06 | −0.15 | −0.14 | −0.14 | −0.05 |
| | 0.1 | −0.001 | −0.002 | −0.002 | −0.001 | −0.001 | −0.04 | −0.08 | −0.07 | −0.05 | −0.05 |
| COKE | 100 | 3.069 | 3.232 | 2.67 | 1.057 | 0.037 | 149.22 | 155.32 | 126.66 | 51.01 | 1.76 |
| Light | 50 | 3.141 | 2.028 | 1.374 | 0.525 | 0.019 | 148.41 | 98.49 | 66.16 | 25.36 | 0.89 |
| | 10 | 1.188 | 0.412 | 0.275 | 0.105 | 0.013 | 53.49 | 19.91 | 13.25 | 5.07 | 0.62 |
| | 5 | 0.593 | 0.205 | 0.136 | 0.052 | 0.004 | 26.67 | 9.89 | 6.57 | 2.51 | 0.18 |
| | 1 | 0.113 | 0.037 | 0.024 | 0.009 | 0.002 | 5.08 | 1.82 | 1.17 | 0.42 | 0.10 |
| | 0.5 | 0.051 | 0.016 | 0.01 | 0.002 | 0.001 | 2.29 | 0.77 | 0.47 | 0.11 | 0.03 |
| | 0.1 | 0.005 | −0.001 | −0.001 | −0.001 | 0.003 | 0.23 | 0.00 | −0.05 | −0.05 | 0.14 |
| | 0.1 | −0.001 | −0.002 | −0.002 | −0.001 | 0.001 | −0.05 | −0.10 | −0.09 | −0.04 | 0.05 |
| COKE | 100 | 3.127 | 3.202 | 2.698 | 1.074 | 0.038 | 149.35 | 154.61 | 128.27 | 51.89 | 1.83 |
| ZERO | 50 | 3.07 | 2.065 | 1.404 | 0.539 | 0.018 | 147.36 | 100.41 | 67.62 | 26.02 | 0.86 |
| | 10 | 1.125 | 0.421 | 0.281 | 0.107 | 0.003 | 50.63 | 20.34 | 13.51 | 5.16 | 0.13 |
| | 5 | 0.567 | 0.212 | 0.14 | 0.053 | 0.001 | 25.51 | 10.22 | 6.76 | 2.56 | 0.05 |
| | 1 | 0.114 | 0.043 | 0.029 | 0.011 | 0.001 | 5.15 | 2.10 | 1.38 | 0.54 | 0.05 |
| | 0.5 | 0.056 | 0.021 | 0.013 | 0.005 | 0.001 | 2.55 | 1.01 | 0.65 | 0.24 | 0.05 |
| | 0.1 | 0.012 | 0.005 | 0.004 | 0.002 | 0.001 | 0.54 | 0.25 | 0.19 | 0.10 | 0.05 |
| | 0.1 | 0.005 | 0.002 | 0 | 0 | −0.001 | 0.23 | 0.06 | 0.01 | 0.00 | −0.05 |
| COKE | 100 | 3.186 | 3.329 | 2.621 | 1.014 | 0.031 | 153.02 | 159.57 | 125.00 | 48.95 | 1.47 |
| LIFE | 50 | 3.159 | 1.966 | 1.321 | 0.502 | 0.015 | 148.39 | 94.53 | 63.60 | 24.23 | 0.71 |
| | 10 | 0.943 | 0.394 | 0.264 | 0.1 | 0.002 | 42.69 | 18.96 | 12.68 | 4.81 | 0.12 |
| | 5 | 0.474 | 0.198 | 0.132 | 0.05 | 0.001 | 21.45 | 9.54 | 6.36 | 2.42 | 0.05 |
| | 1 | 0.095 | 0.04 | 0.026 | 0.01 | 0 | 4.30 | 1.92 | 1.26 | 0.47 | 0.00 |
| | 0.5 | 0.047 | 0.02 | 0.013 | 0.005 | −0.001 | 2.14 | 0.95 | 0.62 | 0.23 | −0.03 |
| | 0.1 | 0.009 | 0.004 | 0.003 | 0.001 | 0 | 0.41 | 0.18 | 0.11 | 0.05 | −0.01 |
| | 0.1 | 0.009 | 0.006 | 0.005 | 0.003 | 0 | 0.45 | 0.28 | 0.23 | 0.15 | 0.00 |
| VOLVIC | 100 | 3.178 | 2.161 | 0.555 | 0.994 | 0.014 | 150.91 | 103.98 | 28.13 | 47.05 | 0.69 |
| Juicy | 50 | 2.525 | 1.072 | 0.274 | 0.488 | 0.01 | 113.29 | 54.03 | 13.86 | 23.06 | 0.46 |
| | 10 | 0.537 | 0.217 | 0.059 | 0.095 | 0.005 | 23.82 | 10.97 | 2.95 | 4.50 | 0.25 |
| | 5 | 0.273 | 0.111 | 0.031 | 0.047 | 0.004 | 12.12 | 5.61 | 1.57 | 2.23 | 0.19 |
| | 1 | 0.05 | 0.017 | 0.002 | 0.003 | −0.005 | 2.21 | 0.91 | 0.11 | 0.16 | −0.24 |
| | 0.5 | 0.021 | 0.005 | −0.003 | −0.002 | −0.006 | 0.90 | 0.28 | −0.12 | −0.10 | −0.29 |
| | 0.1 | 0.001 | −0.002 | −0.004 | −0.004 | −0.006 | 0.03 | −0.09 | −0.18 | −0.16 | −0.29 |
| | 0.1 | −0.002 | −0.004 | −0.004 | −0.004 | −0.006 | −0.10 | −0.16 | −0.19 | −0.19 | −0.28 |
| Apple | 100 | 3.065 | 2.629 | 0.452 | 0.185 | 0.001 | 146.14 | 128.99 | 23.89 | 8.90 | 0.05 |
| Spritzer | 50 | 3.02 | 1.875 | 0.225 | 0.093 | 0.002 | 143.93 | 93.18 | 11.89 | 4.49 | 0.10 |
| | 10 | 1.15 | 0.39 | 0.046 | 0.02 | 0.002 | 49.89 | 20.64 | 2.42 | 0.95 | 0.10 |
| | 5 | 0.581 | 0.197 | 0.026 | 0.012 | 0.002 | 25.25 | 10.41 | 1.33 | 0.56 | 0.10 |
| | 1 | 0.12 | 0.042 | 0.008 | 0.004 | 0.002 | 5.21 | 2.18 | 0.38 | 0.21 | 0.10 |
| | 0.5 | 0.064 | 0.023 | 0.006 | 0.004 | 0.002 | 2.80 | 1.21 | 0.30 | 0.18 | 0.10 |
| | 0.1 | 0.018 | 0.008 | 0.005 | 0.003 | 0.002 | 0.80 | 0.43 | 0.21 | 0.15 | 0.10 |
| | 0.1 | 0.01 | 0.006 | 0.004 | 0.003 | 0.002 | 0.46 | 0.27 | 0.15 | 0.11 | 0.10 |
| SPRITE | 100 | 0.076 | 0.023 | 0.002 | 0 | 0 | 3.66 | 1.10 | 0.12 | 0.00 | 0.00 |
| | 50 | 0.04 | 0.013 | 0.004 | 0.002 | 0.005 | 1.93 | 0.67 | 0.18 | 0.10 | 0.24 |
| | 10 | 0.007 | 0.004 | 0.002 | 0.001 | 0.002 | 0.34 | 0.15 | 0.09 | 0.05 | 0.09 |
| | 5 | 0.003 | 0.001 | 0 | 0 | 0.001 | 0.16 | 0.05 | 0.00 | 0.00 | 0.04 |
| | 1 | 0.001 | 0 | 0.001 | 0 | 0.001 | 0.03 | 0.03 | 0.02 | 0.00 | 0.05 |
| | 0.5 | 0.001 | 0.001 | 0.001 | 0 | 0.001 | 0.03 | 0.02 | 0.02 | 0.03 | 0.05 |
| | 0.1 | 0 | 0.001 | 0.001 | 0.001 | 0.002 | 0.01 | 0.03 | 0.04 | 0.05 | 0.09 |
| | 0.1 | −0.001 | 0.001 | 0 | 0 | 0 | −0.03 | 0.01 | 0.00 | 0.00 | 0.01 |
| SPRITE | 100 | 0.334 | 0.083 | 0.059 | 0.049 | 0.02 | 15.50 | 4.21 | 2.84 | 2.37 | 0.96 |
| ZERO | 50 | 0.136 | 0.024 | 0.014 | 0.012 | 0.01 | 6.29 | 1.14 | 0.67 | 0.58 | 0.48 |
| | 10 | 0.026 | 0.003 | 0.001 | 0.001 | 0.001 | 1.21 | 0.14 | 0.05 | 0.05 | 0.05 |
| | 5 | 0.014 | 0.002 | 0.001 | 0 | 0 | 0.62 | 0.08 | 0.03 | 0.00 | 0.02 |
| | 1 | 0.003 | 0.001 | 0.001 | 0.001 | 0.001 | 0.15 | 0.04 | 0.03 | 0.03 | 0.05 |
| | 0.5 | 0.002 | 0.002 | 0 | 0 | 0.001 | 0.08 | 0.02 | 0.00 | 0.00 | 0.05 |
| | 0.1 | 0 | 0.001 | 0 | 0 | 0 | 0.00 | 0.01 | 0.00 | 0.00 | 0.00 |
| | 0.1 | 0.001 | 0.001 | 0.001 | 0.001 | 0.001 | 0.04 | 0.03 | 0.04 | 0.05 | 0.05 |

Using the results from Table 4, the relative intensity of absorption represented by a whole number multiplied by a factor is shown in Table 5.

TABLE 5

| | Fingerprint | | | | | | | | | |
|---|---|---|---|---|---|---|---|---|---|---|
| | Measured Wavelength, nm | | | | | Gaussian*, nm | | | | |
| Beverage | 285 | 350 | 400 | 500 | 850 | 285 | 350 | 400 | 500 | 850 |
| COKE | 7 | 3 | 2 | 1 | 0 | 5 | 3 | 2 | 1 | 0 |
| COKE Light | 4 | 2 | 1 | 0 | 0 | 6 | 3 | 2 | 1 | 0 |
| COKE ZERO | 7 | 3 | 2 | 1 | 0 | 5 | 3 | 2 | 1 | 0 |
| COKE LIFE | 7 | 3 | 2 | 1 | 0 | 6 | 3 | 2 | 1 | 0 |
| VOL VIC Juicy | 18 | 7 | 2 | 3 | 0 | 16 | 7 | 2 | 3 | 0 |
| Apple Spritzer | 38 | 15 | 2 | 1 | 0 | 33 | 15 | 2 | 1 | 0 |
| SPRITE | 17 | 6 | 1 | 0 | 1 | 3 | 1 | 0 | 0 | 0 |
| SPRITE ZERO | 12 | 2 | 1 | 1 | 1 | 6 | 1 | 1 | 0 | 0 |

*Gaussian Properties: FWHM - 30 nm, Amplitude - 1.5

Both the measured and Gaussian absorbances for varying concentrations of milk, orange juice, COKE, FANTA, FANTA ZERO® (available from the Coca-Cola Company, Atlanta, Ga., USA), lager beer and an energy drink at 285 nm, 350 nm, 400 nm, 500 nm and 850 nm is shown in Table 6.

TABLE 6

| | Absorbance | | | | | | | | | | |
|---|---|---|---|---|---|---|---|---|---|---|---|
| Beverage/ | Measured Wavelength, nm | | | | | | Gaussian, nm | | | | |
| Dairy Product | % | 285 | 350 | 400 | 500 | 850 | 285 | 350 | 400 | 500 | 850 |
| Milk | 100 | 3.651 | 3.739 | 3.762 | 3.803 | 3.298 | 174.28 | 177.97 | 180.06 | 182.14 | 158.28 |
| | 50 | 3.584 | 3.739 | 3.711 | 3.803 | 3.111 | 169.55 | 174.52 | 174.73 | 181.74 | 148.91 |
| | 10 | 3.416 | 3.218 | 2.975 | 3.04 | 2.605 | 162.43 | 148.08 | 143.06 | 144.62 | 124.70 |
| | 5 | 3.244 | 2.902 | 2.744 | 2.727 | 2.247 | 156.84 | 135.98 | 131.86 | 129.83 | 107.63 |
| | 1 | 2.453 | 1.992 | 1.831 | 1.492 | 0.605 | 114.45 | 95.41 | 87.77 | 71.42 | 28.99 |
| | 0.5 | 1.824 | 1.369 | 1.152 | 0.814 | 0.3 | 85.68 | 65.63 | 55.20 | 39.03 | 14.39 |
| Orange Juice | 100 | 3.188 | 3.549 | 3.526 | 3.172 | 1.593 | 152.28 | 166.08 | 169.35 | 150.19 | 76.34 |
| | 50 | 3.151 | 3.48 | 3.024 | 2.295 | 0.977 | 150.47 | 159.86 | 146.65 | 109.84 | 46.80 |
| | 10 | 3.121 | 2.171 | 1.062 | 0.665 | 0.224 | 148.15 | 104.01 | 52.43 | 31.86 | 10.72 |
| | 5 | 2.366 | 1.145 | 0.556 | 0.343 | 0.116 | 110.99 | 55.54 | 27.44 | 16.43 | 5.58 |
| | 1 | 0.52 | 0.23 | 0.113 | 0.07 | 0.028 | 24.53 | 11.16 | 5.56 | 3.37 | 1.32 |
| | 0.5 | 0.27 | 0.115 | 0.057 | 0.036 | 0.017 | 12.72 | 5.58 | 2.81 | 1.72 | 0.80 |
| FANTA | 100 | 3.147 | 1.926 | 0.957 | 0.904 | 0.202 | 150.89 | 93.31 | 47.45 | 41.81 | 9.68 |
| | 50 | 2.611 | 1.015 | 0.508 | 0.476 | 0.109 | 121.60 | 49.71 | 25.19 | 22.01 | 5.20 |
| | 10 | 0.525 | 0.189 | 0.094 | 0.089 | 0.024 | 24.51 | 9.24 | 4.68 | 4.13 | 1.16 |
| | 5 | 0.247 | 0.086 | 0.043 | 0.041 | 0.014 | 11.48 | 4.23 | 2.15 | 1.92 | 0.67 |
| | 1 | 0.064 | 0.024 | 0.013 | 0.012 | 0.008 | 2.99 | 1.17 | 0.64 | 0.58 | 0.38 |
| | 0.5 | 0.036 | 0.015 | 0.009 | 0.008 | 0.007 | 1.71 | 0.73 | 0.44 | 0.39 | 0.33 |
| FANTA | 100 | 3.534 | 1.91 | 0.94 | 0.904 | 0.193 | 162.75 | 92.50 | 46.70 | 41.73 | 9.24 |
| ZERO | 50 | 2.44 | 1.048 | 0.53 | 0.507 | 0.114 | 116.14 | 50.62 | 26.29 | 23.41 | 5.49 |
| | 10 | 0.514 | 0.193 | 0.093 | 0.094 | 0.023 | 24.70 | 9.38 | 4.62 | 4.33 | 1.13 |
| | 5 | 0.264 | 0.096 | 0.046 | 0.048 | 0.015 | 12.59 | 4.65 | 2.30 | 2.20 | 0.72 |
| | 1 | 0.055 | 0.02 | 0.011 | 0.011 | 0.007 | 2.63 | 0.98 | 0.51 | 0.51 | 0.34 |
| | 0.5 | 0.029 | 0.011 | 0.006 | 0.006 | 0.006 | 1.37 | 0.53 | 0.29 | 0.29 | 0.29 |
| Lager Beer | 100 | 3.021 | 2.462 | 0.497 | 0.099 | 0.006 | 145.12 | 121.05 | 26.44 | 4.86 | 0.30 |
| | 50 | 3.016 | 1.478 | 0.254 | 0.053 | 0.007 | 143.89 | 76.42 | 13.49 | 2.60 | 0.33 |
| | 10 | 1.663 | 0.289 | 0.052 | 0.013 | 0.007 | 77.47 | 15.17 | 2.76 | 0.66 | 0.34 |
| | 5 | 0.835 | 0.146 | 0.028 | 0.009 | 0.007 | 39.10 | 7.64 | 1.49 | 0.43 | 0.33 |
| | 1 | 0.158 | 0.032 | 0.009 | 0.005 | 0.006 | 7.46 | 1.66 | 0.47 | 0.24 | 0.29 |
| | 0.5 | 0.082 | 0.019 | 0.007 | 0.005 | 0.006 | 3.88 | 0.98 | 0.36 | 0.22 | 0.29 |
| Energy Drink | 100 | 3.394 | 1.15 | 0.663 | 0.131 | 0.001 | 162.24 | 60.69 | 32.19 | 6.51 | 0.06 |
| | 50 | 3.339 | 0.557 | 0.321 | 0.063 | 0.002 | 146.64 | 29.39 | 15.55 | 3.14 | 0.10 |
| | 10 | 1.351 | 0.1 | 0.058 | 0.012 | 0.002 | 57.66 | 5.33 | 2.81 | 0.58 | 0.10 |
| | 5 | 0.664 | 0.05 | 0.029 | 0.006 | 0.003 | 28.44 | 2.68 | 1.42 | 0.30 | 0.14 |
| | 1 | 0.113 | 0.011 | 0.007 | 0.002 | 0.003 | 4.87 | 0.57 | 0.31 | 0.10 | 0.14 |
| | 0.5 | 0.057 | 0.008 | 0.005 | 0.002 | 0.003 | 2.47 | 0.40 | 0.23 | 0.09 | 0.16 |

Using the results from Table 6, the relative intensity of absorption represented by a whole number multiplied by a factor is shown in Table 7.

TABLE 7

| | Fingerprint | | | | | | | | | |
|---|---|---|---|---|---|---|---|---|---|---|
| Beverage/ | Measured Wavelength, nm | | | | | Gaussian*, nm | | | | |
| Dairy Product | 285 | 350 | 400 | 500 | 850 | 285 | 350 | 400 | 500 | 850 |
| Milk | 7 | 7 | 7 | 7 | 6 | 10 | 8 | 7 | 5 | 2 |
| Orange Juice | 12 | 6 | 3 | 2 | 1 | 12 | 6 | 3 | 2 | 1 |
| FANTA | 5 | 2 | 1 | 1 | 0 | 5 | 2 | 1 | 1 | 0 |
| FANTA ZERO | 5 | 2 | 1 | 1 | 0 | 5 | 2 | 1 | 1 | 0 |
| Lager Beer | 23 | 5 | 1 | 0 | 0 | 20 | 5 | 1 | 0 | 0 |
| Energy Drink | 17 | 2 | 1 | 0 | 0 | 15 | 2 | 1 | 0 | 0 |

*Gaussian Properties: FWHM - 30 nm, Amplitude - 1.5

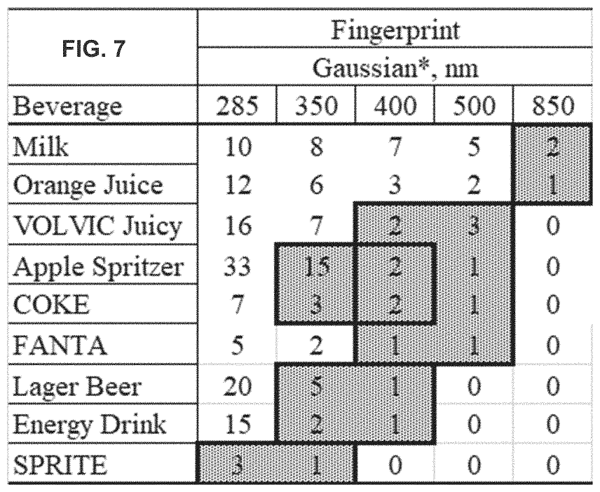

FIG. 7 is a table illustrating the Gaussian-based fingerprint values of certain products of Tables 5 and 7, which shows there is a sufficient separation of absorbance at varying wavelengths to allow either the milk, orange juice, VOLVIC Juicy, apple spritzer, COKE, FANTA, lager beer, energy drink or SPRITE products to be distinguished among the products so identified here.

Using the data from above, Tables 8, 9 and 10 illustrate how COKE, SPRITE, and FANTA products, respectively, having varying levels of sugar may be distinguished among themselves by using the digital fingerprint associated with these products at 225 nm, 270 nm, and 235 nm, respectively.

TABLE 8
COKE Sweeteners Fingerprints

| | Gaussian*, nm | | |
|---|---|---|---|
| Beverage | 225 | 285 | 400 |
| COKE | 6 | 4 | 1 |
| COKE LIFE | 5 | 3 | 1 |
| COKE Light | 9 | 4 | 1 |
| COKE ZERO | 8 | 4 | 1 |

*Gaussian Properties: FWHM—30 nm, Amplitude—1.5

TABLE 9
SPRITE Sweeteners Fingerprints

| | Gaussian*, nm | | |
|---|---|---|---|
| Beverage | 230 | 270 | 320 |
| SPRITE | 18 | 2 | 1 |
| SPRITE ZERO | 40 | 5 | 1 |

*Gaussian Properties: FWHM—30 nm, Amplitude—1.5

TABLE 10
FANTA Sweeteners Fingerprints

| | Gaussian*, nm | | |
|---|---|---|---|
| Beverage | 235 | 400 | 500 |
| FANTA | 8 | 1 | 1 |
| FANTA ZERO | 13 | 1 | 1 |

*Gaussian Properties: FWHM—30 nm, Amplitude—1.5

As the data in Tables 8, 9 and 10 indicates, the technique of the invention is sensitive enough to even detect small changes in the sample, like substitution of sugar in COKE, FANTA and/or SPRITE by other sweeteners. Depending on the use case of the sensor, as further shown herein, other information, like increasing dilution of the product at the start of a cleaning process, could be factored into a possibly more sophisticated data analysis technique.

### Example 3

Table 11 shows the absorbance associated with COKE, COKE Light and COKE ZERO at varying wavelengths having concentrations of 10% and 5% measured using a 1 cm sample cell, while Table 12 shows the relative intensity for COKE, COKE Light and COKE ZERO at varying concentrations at the wavelengths of 225 nm and 280 nm using a 1 cm sample cell.

TABLE 11

Absorbance - 1 cm Sample Cell

| | | |
|---|---|---|
| COKE | COKE Light | COKE ZERO |

Concentration

| Wavelength | 10% | 5% | 10% | 5% | 10% | 5% |
|---|---|---|---|---|---|---|
| 190 | 1.629 | 1.342 | 1.730 | 1.420 | 1.699 | 1.415 |
| 215 | 1.742 | 0.860 | 3.160 | 1.478 | 2.903 | 1.377 |
| 240 | 0.884 | 0.434 | 1.596 | 0.793 | 1.557 | 0.787 |
| 265 | 1.049 | 0.520 | 1.336 | 0.665 | 1.207 | 0.609 |
| 290 | 0.827 | 0.408 | 0.999 | 0.497 | 0.982 | 0.493 |
| 315 | 0.519 | 0.254 | 0.585 | 0.289 | 0.600 | 0.301 |
| 340 | 0.407 | 0.199 | 0.445 | 0.221 | 0.455 | 0.228 |
| 365 | 0.338 | 0.166 | 0.368 | 0.183 | 0.377 | 0.189 |
| 390 | 0.276 | 0.135 | 0.299 | 0.148 | 0.305 | 0.153 |
| 415 | 0.224 | 0.109 | 0.242 | 0.120 | 0.247 | 0.123 |
| 440 | 0.179 | 0.087 | 0.192 | 0.095 | 0.195 | 0.097 |
| 465 | 0.139 | 0.067 | 0.150 | 0.074 | 0.152 | 0.076 |
| 490 | 0.108 | 0.052 | 0.116 | 0.057 | 0.118 | 0.059 |
| 515 | 0.084 | 0.040 | 0.090 | 0.045 | 0.092 | 0.046 |
| 540 | 0.066 | 0.031 | 0.071 | 0.035 | 0.072 | 0.036 |
| 565 | 0.052 | 0.024 | 0.056 | 0.028 | 0.057 | 0.028 |
| 590 | 0.041 | 0.019 | 0.045 | 0.022 | 0.045 | 0.022 |
| 715 | 0.012 | 0.005 | 0.018 | 0.008 | 0.013 | 0.006 |
| 740 | 0.009 | 0.004 | 0.016 | 0.007 | 0.010 | 0.005 |
| 765 | 0.007 | 0.003 | 0.014 | 0.006 | 0.008 | 0.003 |
| 790 | 0.006 | 0.002 | 0.013 | 0.005 | 0.006 | 0.002 |
| 815 | 0.005 | 0.001 | 0.013 | 0.004 | 0.004 | 0.002 |
| 840 | 0.004 | 0.001 | 0.013 | 0.004 | 0.003 | 0.001 |
| 865 | 0.003 | 0.001 | 0.013 | 0.003 | 0.002 | 0.001 |
| 890 | 0.002 | 0.001 | 0.013 | 0.003 | 0.001 | 0.000 |

TABLE 12

Simulated Relative Intensity
1 cm Sample Cell

| | | |
|---|---|---|
| COKE | COKE Light | COKE ZERO |

Wavelength

| Concentration | 225 | 280 | 225 | 280 | 225 | 280 |
|---|---|---|---|---|---|---|
| 100% | 3.427 | 3.159 | 3.427 | 3.127 | 3.437 | 3.117 |
| 50% | 3.427 | 3.132 | 3.427 | 3.121 | 3.437 | 3.106 |
| 10% | 1.205 | 1.090 | 2.274 | 1.347 | 2.200 | 1.230 |
| 5% | 0.596 | 0.540 | 1.134 | 0.671 | 1.109 | 0.621 |
| 1% | 0.110 | 0.100 | 0.222 | 0.130 | 0.225 | 0.126 |
| 0.5% | 0.048 | 0.045 | 0.104 | 0.059 | 0.112 | 0.062 |
| 0.1% | −0.002 | 0.001 | 0.015 | 0.007 | 0.024 | 0.013 |
| 500 ppm | 0.006 | 0.000 | 0.002 | 0.000 | 0.012 | 0.006 |
| 100 ppm | 0.001 | −0.004 | −0.005 | −0.004 | 0.002 | 0.001 |

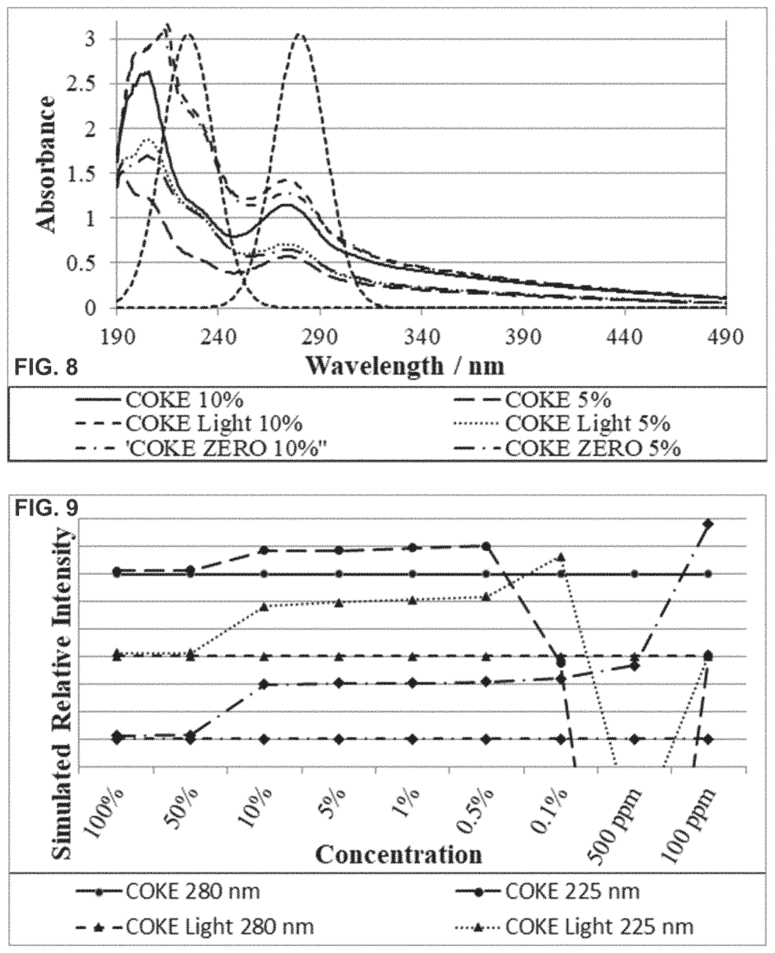

FIG. 8 is a graph showing the absorbance associated with COKE, COKE Light and COKE ZERO at varying wavelengths having concentrations of 10% and 5% measured using a 1 cm sample cell. FIG. 9 is a graph showing the simulated relative intensity for COKE, COKE Light and COKE ZERO at varying concentrations at the wavelengths of 225 nm and 280 nm using a 1 cm sample cell where the Gaussians used to simulate intensities are shown in FIG. 8.

Table 13 shows the absorbance associated with COKE, COKE Light and COKE ZERO at varying wavelengths having concentrations of 5% and 1% but measured using a 5 cm sample cell, while Table 14 shows the simulated relative intensity for COKE, COKE Light and COKE ZERO at varying concentrations at the wavelengths of 225 nm and 280 nm using the 5 cm sample cell.

TABLE 13

| | Absorbance - 5 cm Sample Cell | | | | | |
|---|---|---|---|---|---|---|
| | COKE | | COKE Light | | COKE ZERO | |
| | Concentration | | | | | |
| Wavelength | 5% | 1% | 5% | 1% | 5% | 1% |
| 190 | 1.016 | 0.360 | 0.992 | 0.505 | 0.994 | 0.500 |
| 215 | 2.248 | 0.862 | 2.252 | 1.525 | 2.252 | 1.390 |
| 240 | 2.257 | 0.450 | 3.542 | 0.806 | 3.542 | 0.790 |
| 265 | 2.640 | 0.535 | 3.137 | 0.675 | 2.905 | 0.611 |
| 290 | 2.060 | 0.414 | 2.444 | 0.498 | 2.400 | 0.489 |
| 315 | 1.308 | 0.266 | 1.457 | 0.296 | 1.496 | 0.304 |
| 340 | 1.036 | 0.212 | 1.114 | 0.230 | 1.139 | 0.233 |
| 365 | 0.858 | 0.175 | 0.923 | 0.188 | 0.943 | 0.191 |
| 390 | 0.700 | 0.142 | 0.751 | 0.152 | 0.764 | 0.155 |
| 415 | 0.568 | 0.115 | 0.607 | 0.123 | 0.616 | 0.125 |
| 440 | 0.454 | 0.092 | 0.481 | 0.097 | 0.489 | 0.100 |
| 465 | 0.355 | 0.072 | 0.375 | 0.076 | 0.382 | 0.078 |
| 490 | 0.276 | 0.056 | 0.290 | 0.059 | 0.295 | 0.061 |
| 515 | 0.216 | 0.044 | 0.226 | 0.046 | 0.230 | 0.048 |
| 540 | 0.170 | 0.035 | 0.178 | 0.036 | 0.181 | 0.038 |
| 565 | 0.135 | 0.028 | 0.140 | 0.030 | 0.144 | 0.030 |
| 590 | 0.107 | 0.023 | 0.111 | 0.024 | 0.114 | 0.024 |
| 715 | 0.034 | 0.009 | 0.033 | 0.008 | 0.034 | 0.007 |
| 740 | 0.027 | 0.007 | 0.025 | 0.006 | 0.026 | 0.005 |
| 765 | 0.022 | 0.007 | 0.020 | 0.005 | 0.021 | 0.004 |
| 790 | 0.018 | 0.006 | 0.015 | 0.004 | 0.016 | 0.004 |
| 815 | 0.015 | 0.006 | 0.012 | 0.004 | 0.013 | 0.003 |
| 840 | 0.013 | 0.006 | 0.010 | 0.003 | 0.010 | 0.002 |
| 865 | 0.011 | 0.006 | 0.008 | 0.003 | 0.008 | 0.003 |
| 890 | 0.010 | 0.007 | 0.007 | 0.003 | 0.007 | 0.002 |

TABLE 14

| | Simulated Relative Intensity | | | | | |
|---|---|---|---|---|---|---|
| | 5 cm Sample Cell | | | | | |
| | COKE | | COKE Light | | COKE ZERO | |
| | Wavelength | | | | | |
| Concentration | 225 | 280 | 225 | 280 | 225 | 280 |
| 100% | 3.142 | 3.637 | 3.140 | 3.547 | 3.140 | 3.519 |
| 50% | 3.142 | 3.637 | 3.140 | 3.531 | 3.140 | 3.469 |
| 10% | 3.142 | 3.637 | 3.140 | 3.456 | 3.140 | 3.421 |
| 5% | 3.142 | 2.693 | 3.140 | 3.080 | 3.140 | 2.899 |
| 1% | 0.596 | 0.551 | 1.137 | 0.676 | 1.100 | 0.620 |
| 0.5% | 0.290 | 0.275 | 0.561 | 0.336 | 0.548 | 0.311 |
| 0.1% | 0.040 | 0.055 | 0.100 | 0.064 | 0.105 | 0.063 |
| 500 ppm | 0.013 | 0.027 | 0.044 | 0.030 | 0.050 | 0.032 |
| 100 ppm | −0.011 | 0.005 | −0.004 | 0.002 | 0.001 | 0.005 |

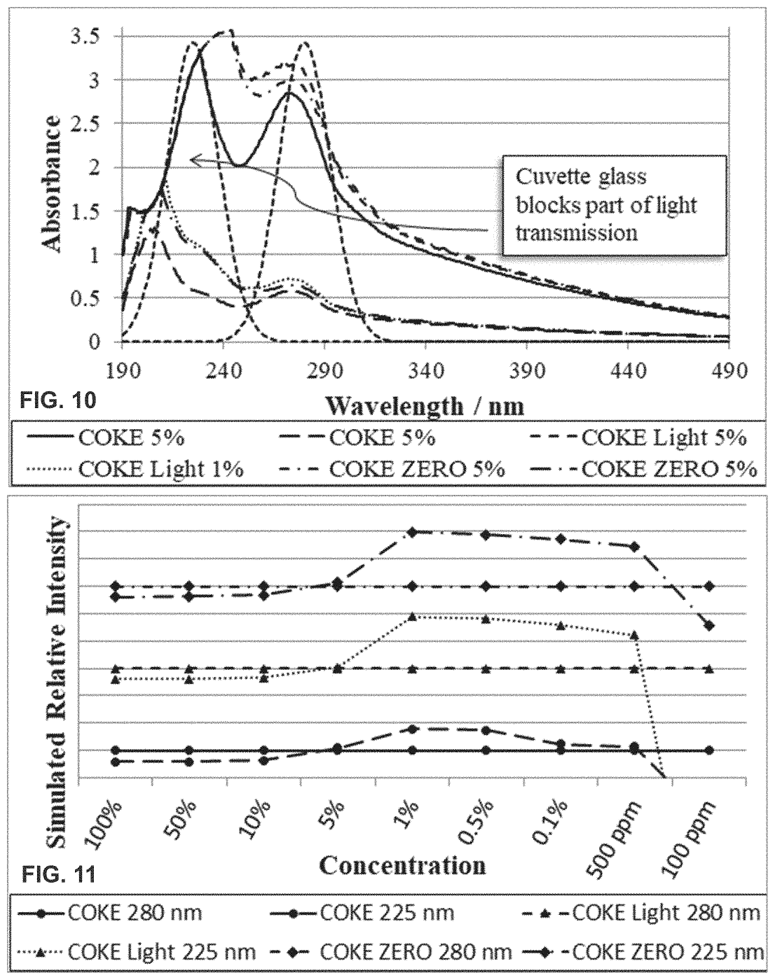

FIG. 10 is a graph showing the absorbance associated with COKE, COKE Light and COKE ZERO at varying wavelengths having concentrations of 5% and 1% measured using a 5 cm sample cell. FIG. 11 is a graph showing the simulated relative intensities for COKE, COKE Light and COKE ZERO at varying concentrations at the wavelengths of 225 nm and 280 nm using a 5 cm sample cell where the Gaussians used to simulate intensities are shown in FIG. 10.

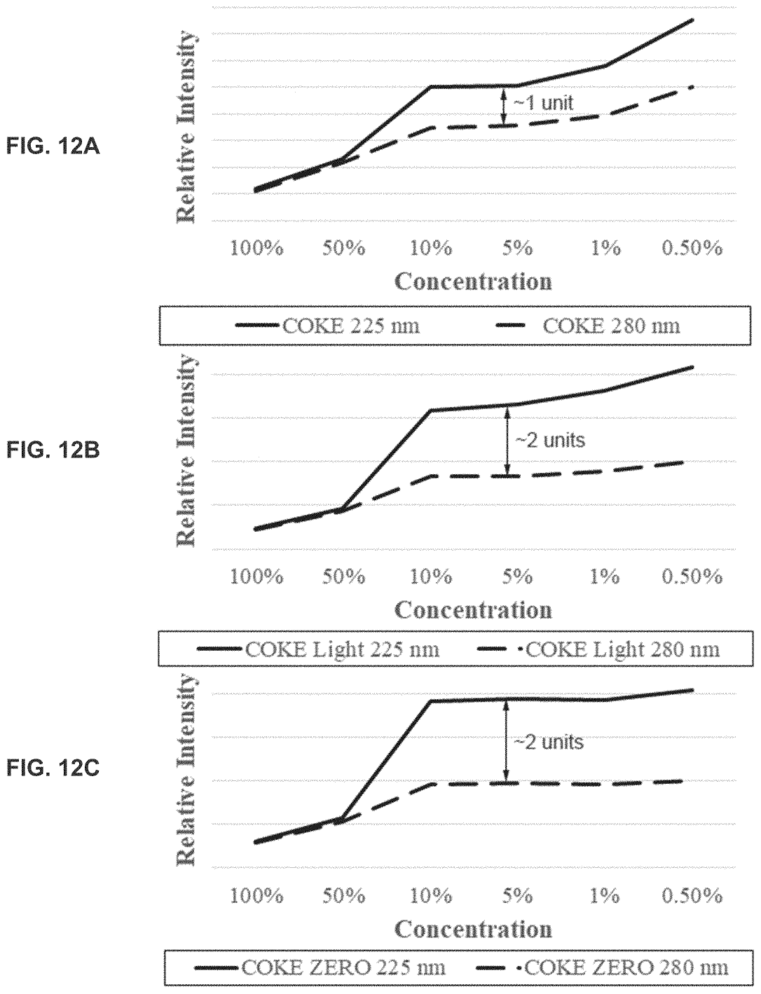

FIGS. 12A, 12B and 12C are graphs showing the relative intensity curves for COKE, COKE Light and COKE ZERO at varying concentrations at the wavelengths of 225 nm and 280 nm, respectively. As these graphs show, the simulated relative intensities of COKE between these two wavelengths is approximately one unit, while the relative intensities of COKE Light and COKE ZERO between these two wavelengths is approximately two units.

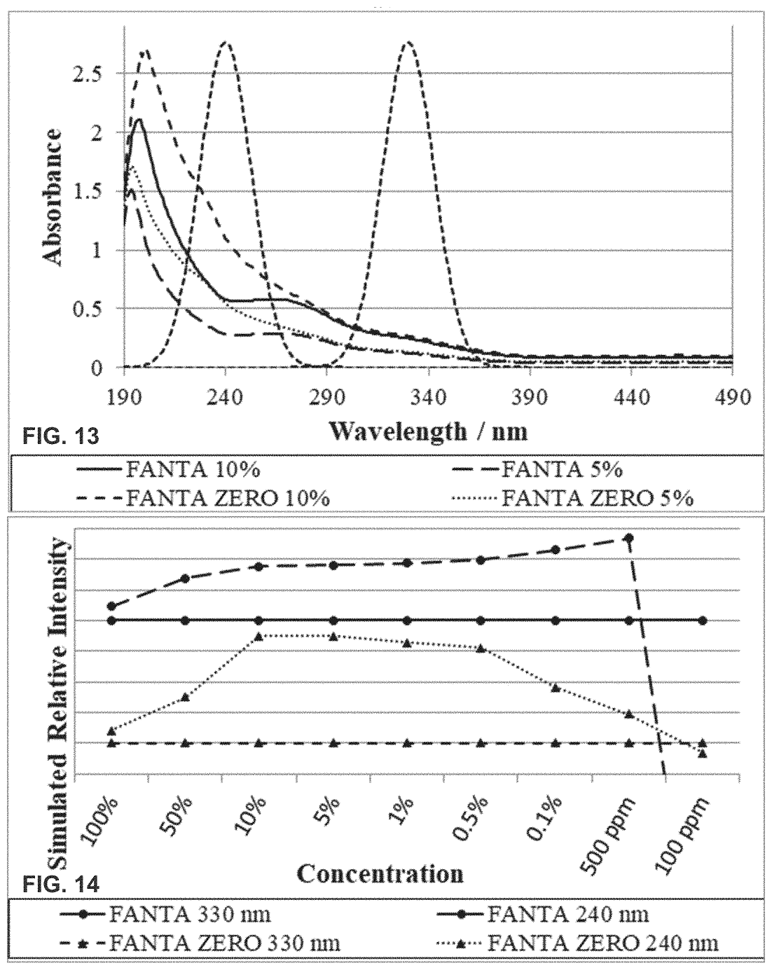

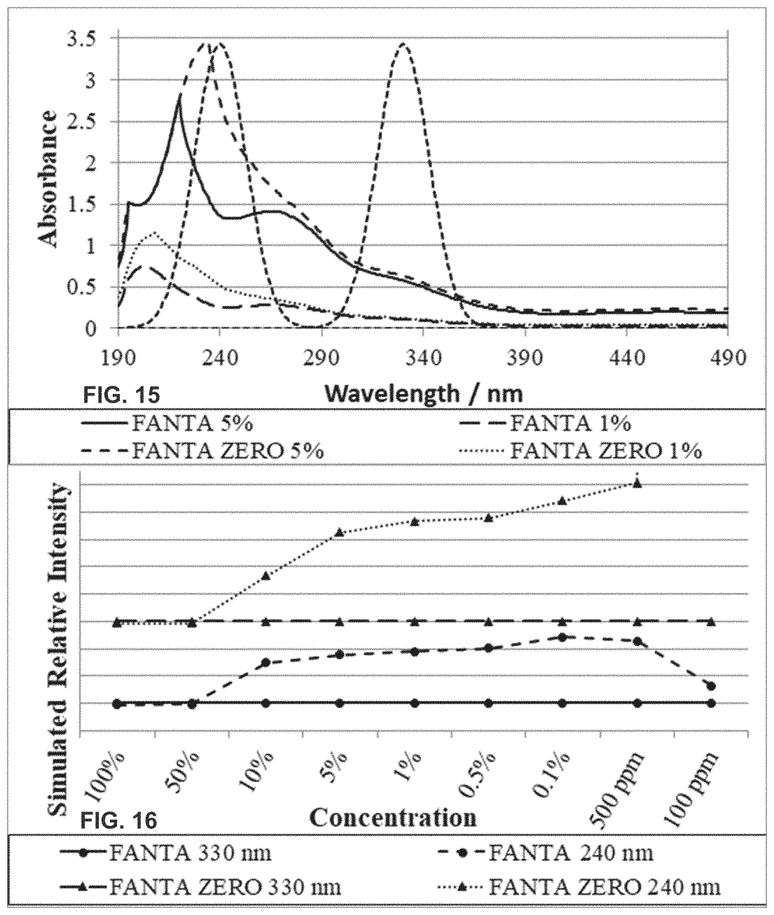

Tests similar to those identified above were performed on FANTA and FANTA ZERO, and SPRITE and SPRITE zero and used to generate the graphs identified that follow. FIG. 13 is a graph showing the absorbance associated with FANTA and FANTA ZERO at varying wavelengths having concentrations of 10% and 5% measured using a 1 cm sample cell. FIG. 14 is a graph showing the simulated relative intensity for FANTA and FANTA ZERO at varying concentrations at the wavelengths of 240 nm and 330 nm using a 1 cm sample cell where the Gaussians used to simulate intensities are shown in FIG. 13. FIG. 15 is a graph showing the absorbance associated with FANTA and FANTA ZERO at varying wavelengths having concentrations of 5% and 1% measured using a 5 cm sample cell. FIG. 16 is a graph showing the simulated relative intensity for FANTA and FANTA ZERO at varying concentrations at the wavelengths of 240 nm and 330 nm using a 5 cm sample cell where the Gaussians used to simulate intensities are shown in FIG. 15.

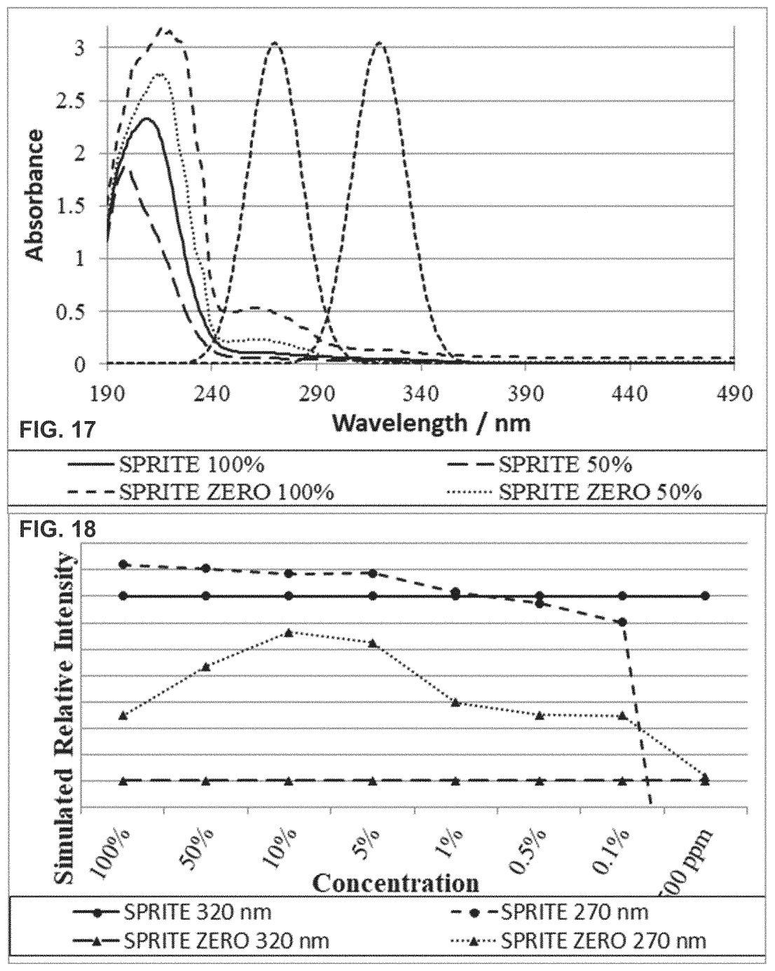

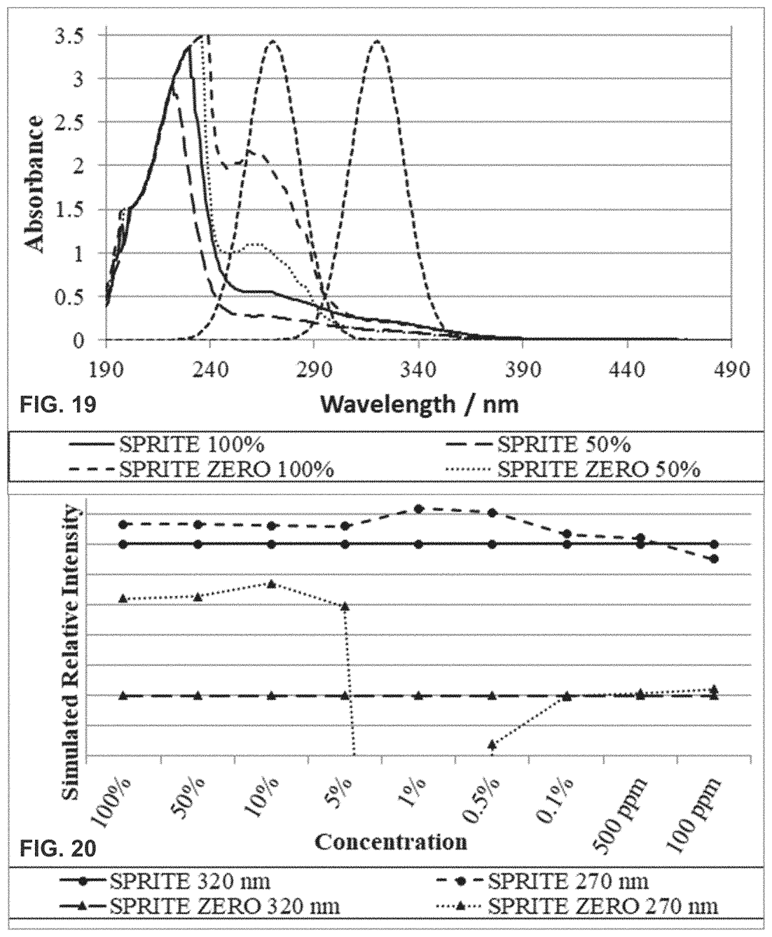

FIG. 17 is a graph showing the absorbance associated with SPRITE and SPRITE ZERO at varying wavelengths having concentrations of 100% and 50% measured using a 1 cm sample cell. FIG. 18 is a graph showing the simulated relative intensity for SPRITE and SPRITE ZERO at varying concentrations at the wavelengths of 270 nm and 320 nm using a 1 cm sample cell where the Gaussians used to simulate intensities are shown in FIG. 17. FIG. 19 is a graph showing the absorbance associated with SPRITE and SPRITE ZERO at varying wavelengths having concentrations of 100% and 50% measured using a 5 cm sample cell. FIG. 20 is a graph showing the simulated relative intensity for SPRITE and SPRITE ZERO at varying concentrations at the wavelengths of 270 nm and 320 nm using a 5 cm sample cell where the Gaussians used to simulate intensities are shown in FIG. 19;

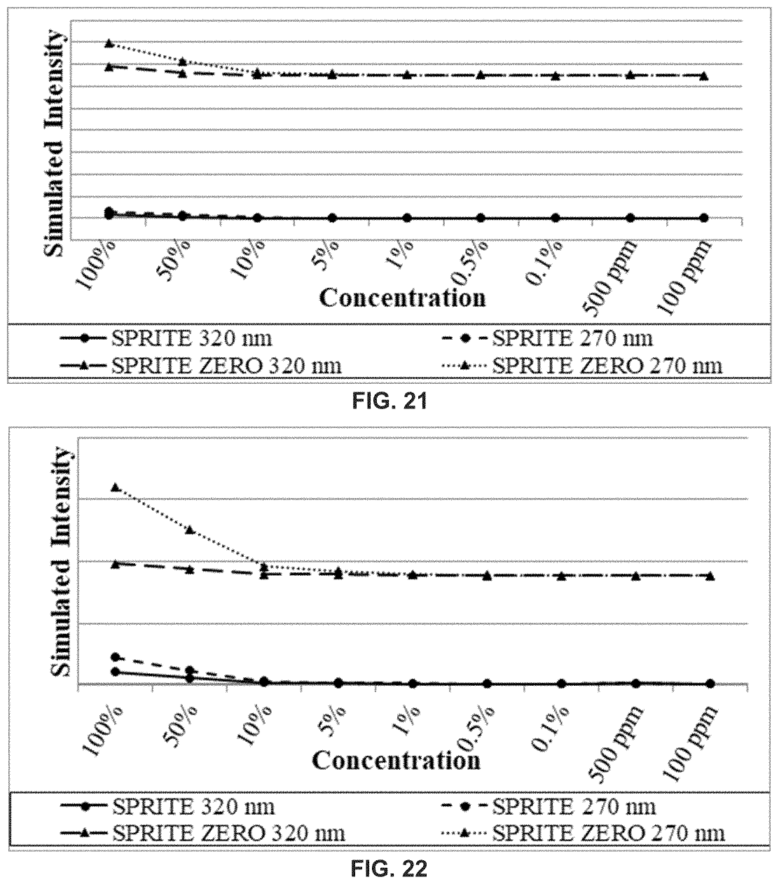

FIG. 21 is a graph showing the simulated intensity for SPRITE and SPRITE ZERO at varying concentrations at the wavelengths of 270 nm and 320 nm using a 1 cm sample cell. In contrast to FIG. 18, which shows the simulated relative intensity for the same wavelengths using a 1 cm sample cell, the simulated relative intensities of FIG. 18 demonstrate to be more distinguishing of the varying concentrations of different product types than the simulated intensities of FIG. 21. Similarly, FIG. 22 is a graph showing the simulated intensity for SPRITE and SPRITE ZERO at varying concentrations at the wavelengths of 270 nm and 320 nm using a 5 cm sample cell. Again, in contrast to FIG. 20, which shows the simulated relative intensity for the same wavelengths using a 5 cm sample cell, the simulated relative intensities of FIG. 20 demonstrate to be more distinguishing of the varying concentrations of different product types than the simulated intensities of FIG. 22.

### Example 4

In order to illustrate the difference between the normalized intensity of actual sensor measurements versus the simulation values used in these examples, Table 15 shows the normalized intensities measured for COKE at 370 nm for two actual sensors, Sensor 1 and Sensor 2, versus the simulation values using a 1 cm sample cell and a 5 cm sample cell respectively.

TABLE 15

| | COKE at 370 nm | | | |
|---|---|---|---|---|
| | Normalized Intensity | | | |
| | | | Simulation | Simulation |
| Concentration | Sensor 1 | Sensor 2 | 1 cm Sample | 5 cm Sample |
| 100% | 1.000 | 1.000 | 1.000 | 1.000 |
| 50% | 0.999 | 0.999 | 0.545 | 1.000 |
| 10% | 0.590 | 0.612 | 0.107 | 0.423 |
| 5% | 0.293 | 0.330 | 0.052 | 0.211 |
| 1% | 0.017 | 0.068 | 0.009 | 0.043 |
| 0.5% | −0.018 | 0.034 | 0.003 | 0.021 |
| 0.1% | −0.048 | 0.006 | −0.001 | 0.005 |
| 500 ppm | −0.051 | 0.003 | 0.000 | 0.002 |
| 100 ppm | −0.054 | 0.000 | −0.001 | 0.001 |

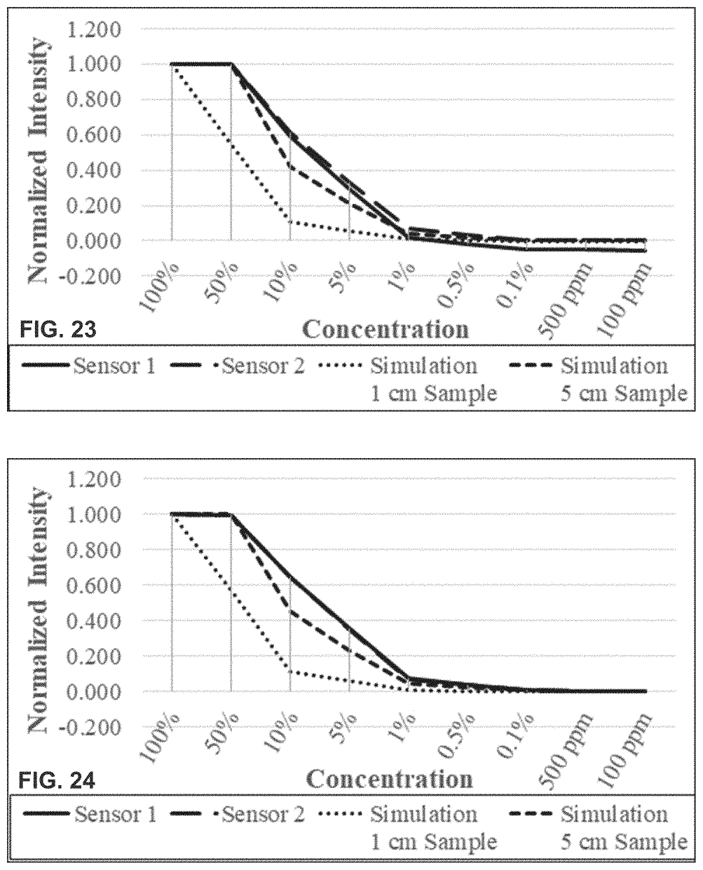

FIG. 23 is a graph showing the normalized intensity for COKE at varying concentrations at 370 nm using Sensor 1 and Sensor 2, two actual sensors, and simulation values measured using a 1 cm sample cell and a 5 cm sample cell, respectively. The graph in FIG. 23 shows that the simulation values found using the 5 cm sample cell compare well with the actual sensor measurements taken using Sensor 1 and Sensor 2, and while the simulation values found using the 1 cm sample cell track in terms of magnitude, they do not match the actual measurements for varying concentration at concentrations greater than about 1% of COKE.

Similarly, Table 16 shows the normalized intensities measured for COKE Light at 370 nm for two actual sensors, Sensor 1 and Sensor 2, versus the simulation values using a 1 cm sample cell and a 5 cm sample cell respectively.

TABLE 16

| | COKE Light at 370 nm | | | |
|---|---|---|---|---|
| | Normalized Intensity | | | |
| | | | Simulation | Simulation |
| Concentration | Sensor 1 | Sensor 2 | 1 cm Sample | 5 cm Sample |
| 100% | 1.000 | 1.000 | 1.000 | 1.000 |
| 50% | 0.999 | 0.999 | 0.570 | 1.000 |
| 10% | 0.647 | 0.647 | 0.115 | 0.456 |
| 5% | 0.353 | 0.353 | 0.057 | 0.227 |
| 1% | 0.071 | 0.067 | 0.010 | 0.046 |
| 0.5% | 0.035 | 0.034 | 0.004 | 0.023 |
| 0.1% | 0.005 | 0.005 | 0.000 | 0.004 |
| 500 ppm | 0.001 | 0.001 | −0.001 | 0.002 |
| 100 ppm | −0.001 | −0.003 | −0.001 | 0.000 |

FIG. 24 is a graph showing the normalized intensity for COKE Light at varying concentrations at 370 nm using Sensor 1 and Sensor 2, two actual sensors, and simulation values measured using a 1 cm sample cell and a 5 cm sample cell, respectively. Similar to the results found for COKE, the graph in FIG. 24 shows that the simulation values found using the 5 cm sample cell compare well with the actual sensor measurements taken using Sensor 1 and Sensor 2, and while the simulation values found using the 1 cm sample cell track in terms of magnitude, do not match the actual measurements for varying concentration at concentrations greater than about 1% of COKE Light. Of course, other sample cell track sizes may be used. For example, a 3.8 cm sample cell track has been used in practice and similarly compares to the results of the 5 cm sample cell. While the 1 cm sample cell still provides a good signal for a 50% concentration of COKE Light, the actual sensors used in this test and the 5 cm sample cell show normalized intensities that are out of range to be able to adequately distinguish between the 50% and 100% concentration ranges. At 1% concentration, the actual sensors and the 5 cm sample cell show a detectable and distinguishable signal in comparison to the other concentrations, while the 1 cm sample cell does not show a signal that may be used to detect varying normalized intensities at concentrations of 1% or less.

Finally, Table 17 shows the normalized intensities measured for COKE ZERO at 370 nm for two actual sensors, Sensor 1 and Sensor 2, versus the simulation values using a 1 cm sample cell and a 5 cm sample cell respectively.

TABLE 17

| | COKE ZERO at 370 nm | | | |
|---|---|---|---|---|
| | Normalized Intensity | | | |
| | | | Simulation | Simulation |
| Concentration | Sensor 1 | Sensor 2 | 1 cm Sample | 5 cm Sample |
| 100% | 1.000 | 1.000 | 1.000 | 1.000 |
| 50% | 0.999 | 0.999 | 0.577 | 1.000 |
| 10% | 0.656 | 0.655 | 0.116 | 0.463 |
| 5% | 0.359 | 0.359 | 0.058 | 0.232 |
| 1% | 0.073 | 0.073 | 0.012 | 0.047 |
| 0.5% | 0.035 | 0.035 | 0.006 | 0.024 |
| 0.1% | 0.004 | 0.004 | 0.002 | 0.005 |
| 500 ppm | 0.396 | 0.133 | 0.000 | 0.002 |
| 100 ppm | −0.003 | −0.003 | 0.000 | 0.000 |

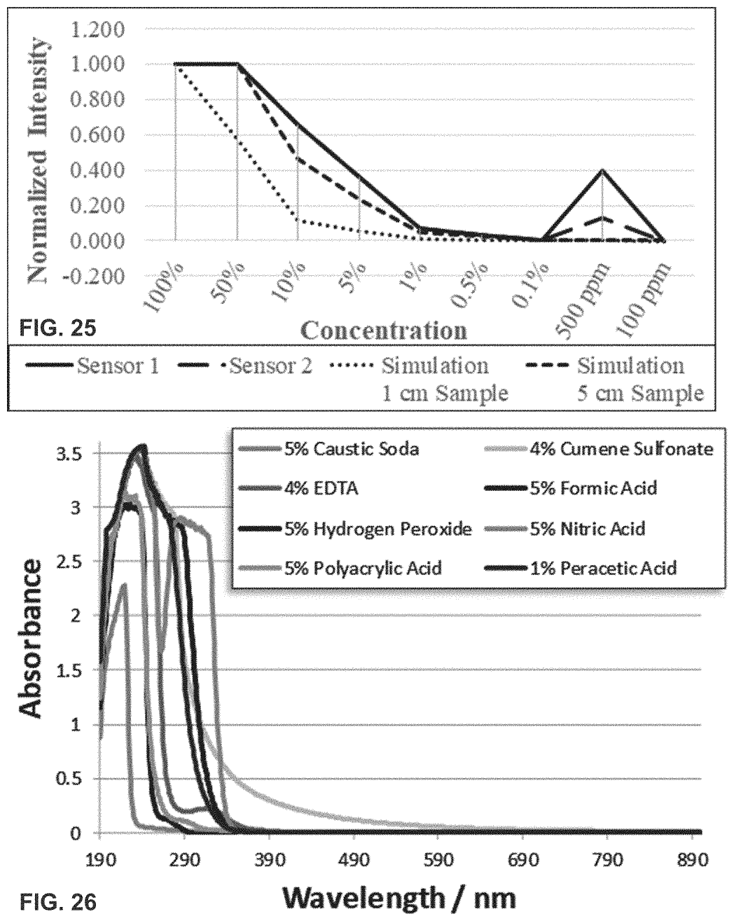

FIG. 25 is a graph showing the normalized intensity for COKE ZERO at varying concentrations at 370 nm using Sensor 1 and Sensor 2, two actual sensors, and simulation values measured using a 1 cm sample cell and a 5 cm sample cell, respectively. Again, similar to the results found for COKE and COKE Light, the graph in FIG. 25 shows that the simulation values found using the 5 cm sample cell compare well with the actual sensor measurements taken using Sensor 1 and Sensor 2, and while the simulation values found using the 1 cm sample cell track in terms of magnitude, they do not match the actual measurements for varying concentration at concentrations greater than about 1% of COKE ZERO. However, a situation that is unique to COKE ZERO, the actual sensors demonstrated an increase in normalized intensity at the 500 ppm concentration. This increase was neither demonstrated by the simulation values found using the 1 cm sample cell nor the simulation values found using the 5 cm sample cell.

### Example 5

Similar tests were conducted for raw materials that may be used in cleaning formulations, wherein such formulations may have different types and varying concentrations of such compounds. FIG. 26 is a graph showing the absorbance of raw materials that may be used in cleaning formulations at varying wavelengths in the UV range having different compounds included in the formulation.

The results provided in the Examples above demonstrates the invention is capable of identifying the types of chemicals, materials or products being processed; the concentration of those chemicals, materials and/or products; the quality of those chemicals, materials and/or products; and the properties associated with such chemicals, materials and/or products. Without intending to be bound by the theory, the absorption information converted to relative intensities and the differences identified in the magnitudes thereof is suitable for a cost-effective use in a real-time processing environment. While certainly it is feasible to conduct a full spectrum analysis in a data intensive application, the costs of analyzers associated therewith is much greater than the analyzer that may be utilized for the analyses of the invention.

Many modifications and other embodiments of the invention set forth herein will come to mind to one skilled in the art to which this invention pertains having the benefit of the teachings presented in the descriptions herein. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

That which is claimed:

1. A method for analyzing a sample comprising:
emitting two or more different spectral wavelengths of electromagnetic radiation through the sample;
detecting a signal representing the two or more different spectral wavelengths of electromagnetic radiation transmitted through the sample;
processing the signal to determine relative intensities of absorption of the two or more different spectral wavelengths;
using an analysis technique to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and
identifying at least one of a type of a constituent of the sample, a dilution of the constituent in the sample and one or more properties of the constituent of the sample.

2. The method of claim 1, wherein the electromagnetic radiation includes any one or more of visible light, ultraviolet radiation, and infrared radiation.

3. The method of claim 1, wherein the signal represents energy released by a luminescent species naturally present within the sample that becomes excited upon absorbance of at least one of the two or more different spectral wavelengths of electromagnetic radiation transmitted through the sample.

4. The method of claim 1, wherein the sample in one includes one of a food, a cleaning formulation, a detergent formulation, a sealant formulation, an adhesive formulation, a preparation for medical or veterinary purposes, a pharmaceutical, a cosmetic, a lotion, a hair gel, a shampoo, a paint, a varnish, a lacquers, a thinner and a thickener.

5. The method of claim 1, wherein the constituent is a food in liquefied form.

6. The method of claim 5, wherein the food in liquefied form is at least one of a beverage and a dairy product.

7. The method of claim 5, wherein the food in liquefied form is a condiment.

8. The method of claim 1, wherein the constituent is a contaminant.

9. The method of claim 1, wherein the sample is from a process plant.

10. The method of claim 9, wherein the sample is from a cleaning process.

11. The method of claim 10, wherein the cleaning process is a cleaning process from any industry.

12. The method of claim 10, wherein the cleaning process is selected from a group consisting of a food cleaning process, a beverage cleaning process, a dairy products cleaning process, a laundry cleaning system, and a dishwasher.

13. The method of claim 9, wherein the sample is taken from a process stream.

14. The method of claim 9 additionally comprising identifying a modification to be made to an operation of the process plant.

15. The method of claim 14, wherein the process plant is an automated recirculation system.

16. The method of claim 15, wherein the automated recirculation system is a clean-in place (CIP) process.

17. The method of claim 16, wherein the operation is a cleaning procedure.

18. The method of claim 16, wherein the sample is taken from at least one of a supply line of the CIP process and a return line of the CIP process.

19. The method of claim 16, wherein the sample is taken from a supply line of the CIP process and another sample is taken from a return line of the CIP process.

20. The method of claim 19, additionally comprising using information from the sample and the another sample in identifying the modification to be made to the operation of the process.

21. A method for analyzing a sample comprising:
emitting two or more different spectral wavelengths of electromagnetic radiation through the sample;
detecting a signal representing the two or more different spectral wavelengths of electromagnetic radiation transmitted through the sample;
processing the signal to determine relative intensities of absorption of the two or more different spectral wavelengths;
using an analysis technique configured to employ a mathematical procedure comprising a mathematical model to compare the relative intensities of absorption of the sample to any of relative intensities of absorption of a multiplicity of liquid types, relative intensities of absorption for a dilution of the multiplicity of liquid types and relative intensities of absorption of various properties associated with the multiplicity of liquid types; and
identifying at least one of a type of a constituent of the sample, a dilution of the constituent in the sample and one or more properties of the constituent of the sample.

22. The method of claim 21, wherein the signal represents energy released by a luminescent species naturally present within the sample that becomes excited upon absorbance of at least one of the two or more different spectral wavelengths of electromagnetic radiation transmitted through the sample.

23. The method of claim 21, wherein the mathematical model includes any one or more of a linear model, a nonlinear model, a static model, a dynamic model, a discrete model, a continuous model, an explicit model, an implicit model, a deterministic model, a statistical model, a deductive model, and an inductive model.

24. An analyzer comprising:
light emitting diodes (LEDs) that provide two or more different spectral wavelengths of electromagnetic radiation;
a detector that identifies a signal that represents the two or more different spectral wavelengths of electromagnetic radiation transmitted through a sample;
a processor that identifies relative intensities of absorption from the signal;
a data repository to hold relative intensities of absorption of a multiplicity of liquid types, relative intensities of absorption for a dilution of the multiplicity of liquid types and relative intensities of absorption of various properties associated with the multiplicity of liquid types; and
an evaluator having an analysis technique to compare the relative intensities of absorption of the sample to the relative intensities of absorption in the data repository and to identify at least one of a type of a constituent of the sample, a dilution of the constituent in the sample and one or more properties of the constituent of the sample.

25. The analyzer of claim 24, wherein the signal represents energy released by a luminescent species naturally present within the sample that becomes excited upon absorbance of at least one of the two or more different spectral wavelengths of electromagnetic radiation transmitted through the sample.

26. The analyzer of claim 24, wherein the analysis technique is configured to employ a mathematical procedure to compare the relative intensities of absorption of the sample to the relative intensities of absorption in the data repository.

27. The analyzer of claim 25, wherein the mathematical procedure comprises a mathematical model.

28. The analyzer of claim 27, wherein the mathematical model includes any one or more of a linear model, a nonlinear model, a static model, a dynamic model, a discrete model, a continuous model, an explicit model, an implicit model, a deterministic model, a statistical model, a deductive model, and an inductive model.

29. The analyzer of claim 24, wherein the electromagnetic radiation includes any one or more of visible light, ultraviolet radiation, and infrared radiation.

30. The analyzer of claim 24, wherein the constituent is a food in liquefied form.

31. The analyzer of claim 30, wherein the food in liquefied form is at least one of a beverage and a dairy product.

32. The method of claim 24, wherein the food in liquefied form is a condiment.

33. The method of claim 24, wherein the constituent is a contaminant.

34. The analyzer of claim 24, wherein the sample is from a process plant.

35. The method of claim 33, wherein the sample is from a cleaning process.

36. The analyzer of claim 34, wherein the sample is taken from a process stream.

37. The analyzer of claim 34, wherein the process plant is an automated recirculation system.

38. The analyzer of claim 37, wherein the automated recirculation system is a clean-in place (CIP) process.

39. The analyzer of claim 38, wherein the sample is taken from at least one of a supply line of the CIP process and a return line of the CIP process.

40. The analyzer of claim 38, wherein the sample is taken from a supply line of the CIP process and another sample is taken from a return line of the CIP process.
